(19) United States
(12) Patent Application Publication
(10) Pub. No.: US 2025/0010221 A1
(43) Pub. Date: Jan. 9, 2025

(54) MULTIPHASE GAS/BUBBLE DIVERTER

(71) Applicant: IRPI LLC, Wilsonville, OR (US)

(72) Inventors: Mark M. Weislogel, Newberg, OR (US); Logan J. Torres, Hillsboro, OR (US); Ryan M. Jenson, Happy Valley, OR (US)

(21) Appl. No.: 18/764,019

(22) Filed: Jul. 3, 2024

Related U.S. Application Data
(60) Provisional application No. 63/512,246, filed on Jul. 6, 2023.

(51) Int. Cl. B01D 19/00

(52) U.S. Cl. CPC B01D 19/0031

(57) ABSTRACT

Methods and systems are provided for a multiphase gas/bubble diverting device. A multiphase gas/bubble diverter comprises a body with an inlet at a first end of the body and a first outlet and a second outlet at a second end of the body, opposite the first end. The multiphase gas/bubble diverter further comprises a screening element that divides an internal cavity of the body into a first sub-chamber that fluidly couples the inlet to the first outlet, and a second sub-chamber that is fluidly coupled to the second outlet. The screening element diverts all bubble and gas flow out of the multiphase gas/bubble diverter via the first outlet while diverting 100% liquid out of the multiphase gas/bubble diverter via the second outlet.

### CROSS REFERENCE TO RELATED APPLICATIONS

The present application claims priority to U.S. Provisional Application No. 63/512,246, entitled “MULTIPHASE SCREEN SEPARATOR”, and filed on Jul. 6, 2023. The entire contents of the above-listed application are hereby incorporated by reference for all purposes.

### FIELD

The present description relates generally to liquid, gas, and/or solid phase separating devices.

### BACKGROUND/SUMMARY

Numerous challenges are faced by the designers of life support systems for spacecraft because of the persistently unfamiliar and unforgiving low-gravity (low-g) environment. Many low-gravity fluid systems ultimately experience multiphase flow conditions, thereby requiring phase separation and management technology. A common challenge is the collection (filtration) of gas bubbles from liquid streams. Liquid-gas phase separations are pervasive and desired in numerous engineering systems (e.g., liquid-gas sorbent chemistry, filtration, HVAC, demisters, firefighting equipment, and others). In low-g environments, gravity may not be leveraged to create buoyancy forces that passively separate fluids (e.g., liquids and gases) of different densities. Such systems are often directly tied to life support systems such as oxygen supply, air revitalization, thermal management systems, water reclamation, medical fluids, and so on. Prior solutions include active separators and passive methods which possess serious shortcomings of complexity and pressure drop. Active separators involve moving parts, which are disadvantageous due to added potential points of degradation that reduce reliability while increasing mass, power consumption, and noise. Passive methods, including vortex/cyclone generators and capillary devices such as membranes, wicks, and conduits, may also be disadvantageous due to their mass and complexity. Centrifuge based phase separation devices use complex electro-mechanical system design, constant power, and large mass and volume envelopes. Bubble membrane filters are more energy efficient than centrifuges but suffer from increased pressure losses, pump power increases, and special sensitivity to clogging and biofouling. To date, the challenge resides in providing robust phase separation across a range of flow rates and inlet conditions. Therefore, a low pressure drop liquid-gas phase separation device capable of largely passive liquid droplet and gas bubble separation and collection across a broad range of flow rates and inlet conditions is desired.

Described herein are methods and systems for a multiphase gas/bubble diverter. A multiphase gas/bubble diverter comprises a body with an inlet at a first end of the body and a first outlet and a second outlet at a second end of the body, opposite the first end. The multiphase gas/bubble diverter further comprises a screening element that divides an internal cavity of the body into a first sub-chamber that fluidly couples the inlet to the first outlet, and a second sub-chamber that is fluidly coupled to the second outlet. The multiphase gas/bubble diverter exploits passive separation conditions where one of the phases is desired to be separated to a high degree (e.g., 100%). Gas and liquid are separated by the screening element via passive capillary fluidic phenomena using wetting phenomena, geometry, and fluid properties. In a method for separating multiphase flow using the device, a two-phase flow enters the device with bubbles directed away from a (bubble point) grating through which liquid enters and gas is blocked from entering. The increasing gas content flow is diverted along a separate leg while high quality liquid exits along a separate path for downstream processing. The operable dimensions, flow rates, and flow rate ratios of the diverter are determined by the downstream inertial and viscous resistances. The device may be primed, such as by flowing 100% liquid through the device to remove gas bubbles in the first sub-chamber, prior to flowing a single-phase gas flow through the device. When the device has been primed, the single-phase gas flow may be entirely diverted through the device without bubbles exiting through a liquid outlet (e.g., the second outlet).

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a first perspective view of a first example multiphase gas/bubble diverter.

FIG. 2 shows a second perspective view of the first example multiphase gas/bubble diverter.

FIG. 3 shows a top view of the first example multiphase gas/bubble diverter.

FIG. 4 shows a first cross-sectioned side view of the first example multiphase gas/bubble diverter.

FIG. 5 shows a cross-sectioned end view of the first example multiphase gas/bubble diverter.

FIG. 6 shows a cross-sectioned perspective view of the first example multiphase gas/bubble diverter.

FIG. 7 shows a second cross-sectioned side view of the first example multiphase gas/bubble diverter.

FIG. 8 shows a third cross-sectioned side view of the first example multiphase gas/bubble diverter.

FIG. 9 shows a side view of a second example multiphase gas/bubble diverter.

FIG. 10 shows a first perspective view of the second example multiphase gas/bubble diverter.

FIG. 11 shows a second perspective view of the second example multiphase gas/bubble diverter.

FIG. 12 shows a cross-sectioned side view of the second example multiphase gas/bubble diverter.

FIG. 13 shows a first cross-sectioned end view of the second example multiphase gas/bubble diverter.

FIG. 14 shows a second cross-sectioned end view of the second example multiphase gas/bubble diverter.

FIG. 15 shows a third cross-sectioned end view of the second example multiphase gas/bubble diverter.

FIG. 16 shows a cross-sectioned perspective view of the second example multiphase gas/bubble diverter.

FIG. 17 shows a first perspective view of a third example multiphase gas/bubble diverter.

FIG. 18 shows a second perspective view of the third example multiphase gas/bubble diverter.

FIG. 19 shows a cross-sectioned side view of the third example multiphase gas/bubble diverter.

FIG. 20 shows a first cross-sectioned end view of the third example multiphase gas/bubble diverter.

FIG. 21 shows a second cross-sectioned end view of the third example multiphase gas/bubble diverter.

FIG. 22 shows a third cross-sectioned end view of the third example multiphase gas/bubble diverter.

FIG. 23 shows a first perspective view of a fourth example multiphase gas/bubble diverter.

FIG. 24 shows a second perspective view of the fourth example multiphase gas/bubble diverter.

FIG. 25 shows a cross-sectioned side view of the fourth example multiphase gas/bubble diverter.

FIG. 26 shows a first cross-sectioned end view of the fourth example multiphase gas/bubble diverter.

FIG. 27 shows transparent side views of different configurations of the fourth example multiphase gas/bubble diverter.

FIG. 28 shows a first perspective view of a fifth example multiphase gas/bubble diverter.

FIG. 29 shows a second perspective view of the fifth example multiphase gas/bubble diverter.

FIG. 30 shows a cross-sectioned side view of the fifth example multiphase gas/bubble diverter.

FIG. 31 shows a cross-sectioned top view of the fifth example multiphase gas/bubble diverter.

FIG. 32 shows a cross-sectioned perspective view of the fifth example multiphase gas/bubble diverter.

FIG. 33 shows transparent side views of different configurations of the fifth example multiphase gas/bubble diverter.

FIG. 34 shows a first perspective view of a sixth example multiphase gas/bubble diverter.

FIG. 35 shows a second perspective view of the sixth example multiphase gas/bubble diverter.

FIG. 36 shows a cross-sectioned side view of the sixth example multiphase gas/bubble diverter.

FIG. 37 shows a cross-sectioned perspective view of the sixth example multiphase gas/bubble diverter.

FIG. 38 shows a cross-sectioned end view of the sixth example multiphase gas/bubble diverter.

FIG. 39 shows an example multiphase separating system including the second example multiphase gas/bubble diverter of FIGS. 9-16.

FIG. 40 shows a flow chart of a method for multiphase separation using one or more of the example multiphase gas/bubble diverters of FIGS. 1-38.

### DETAILED DESCRIPTION

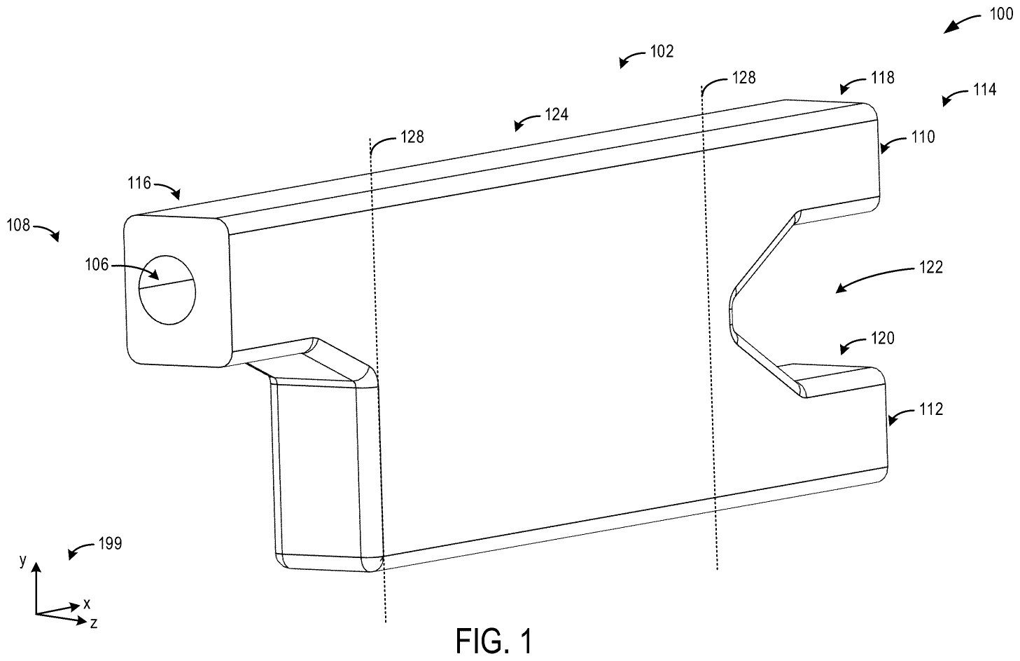

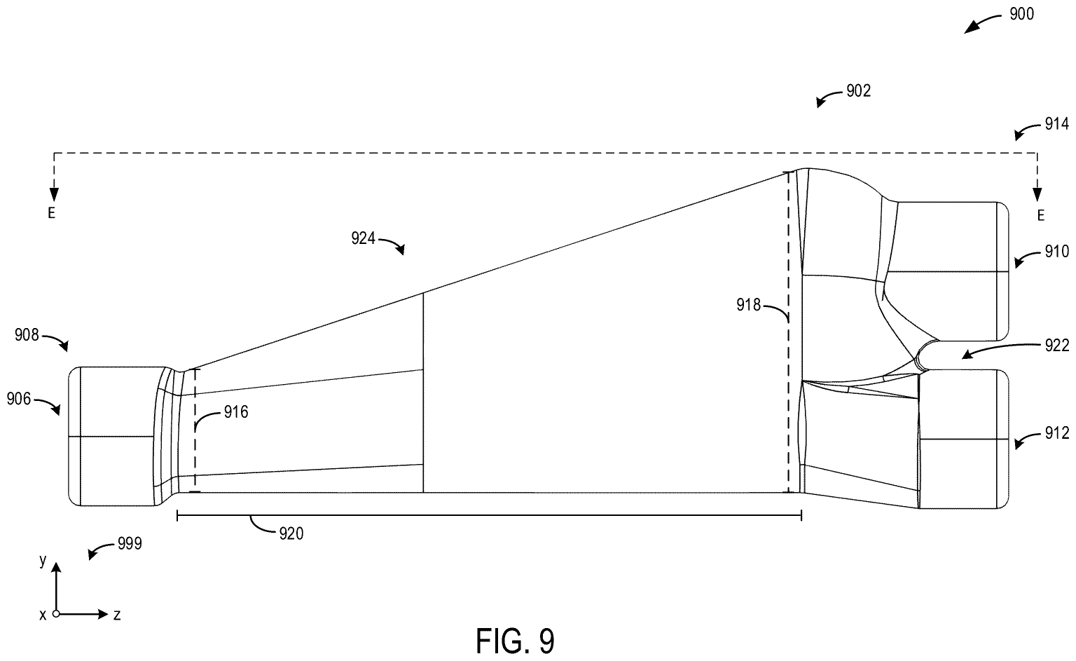

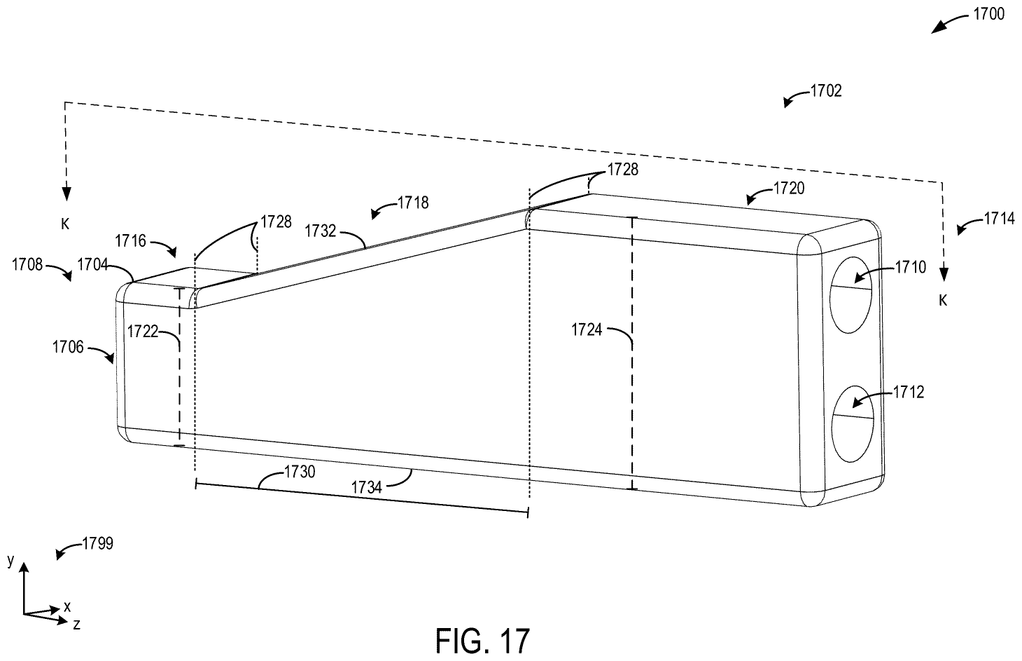

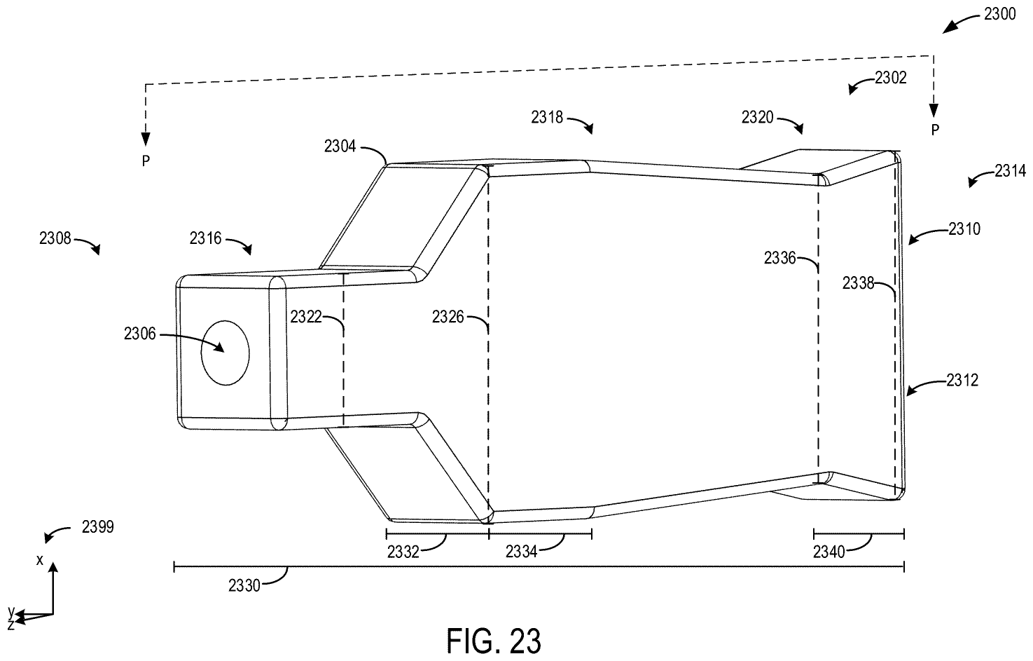

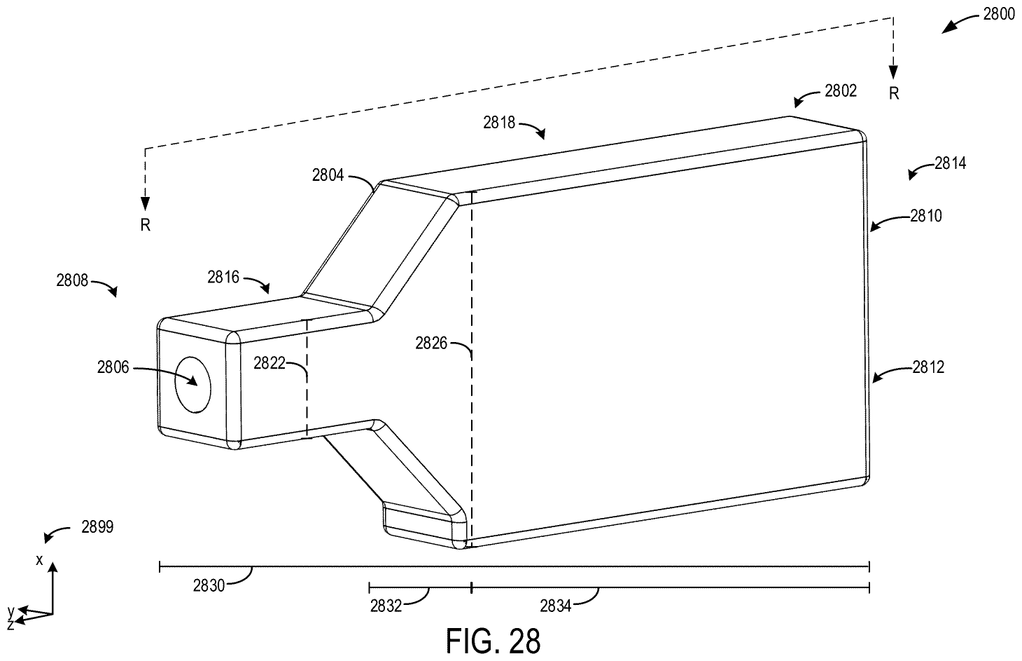

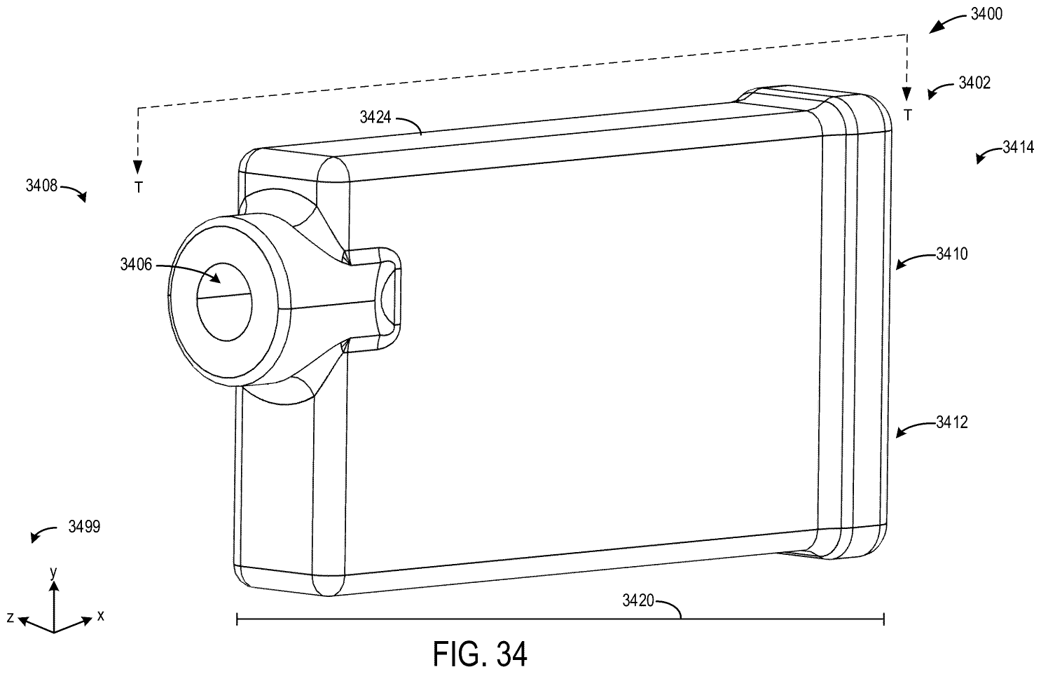

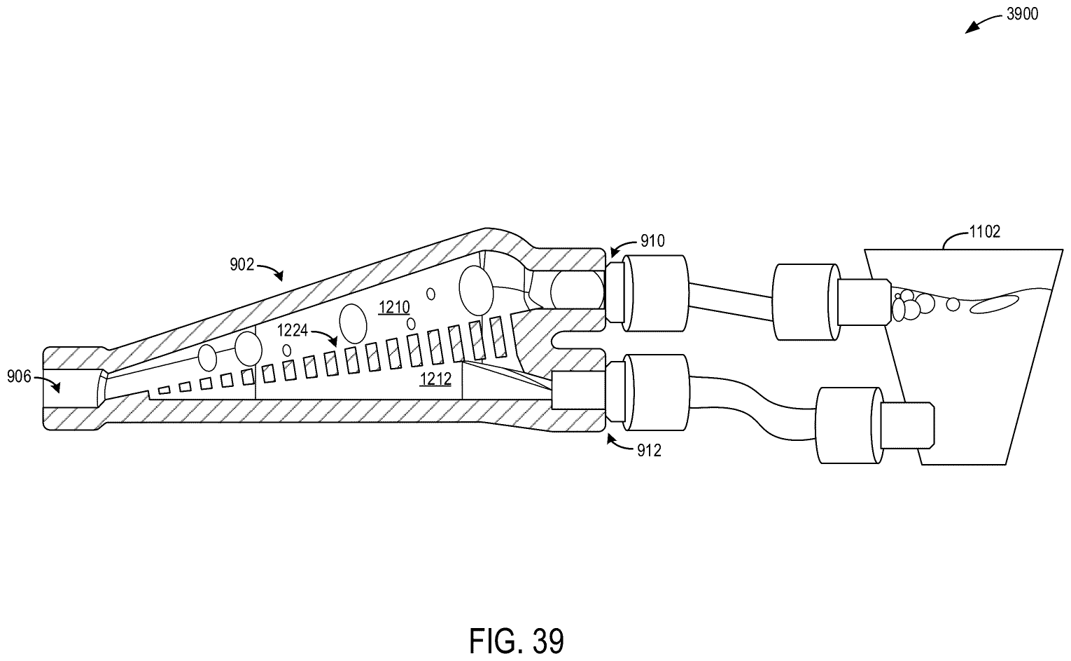

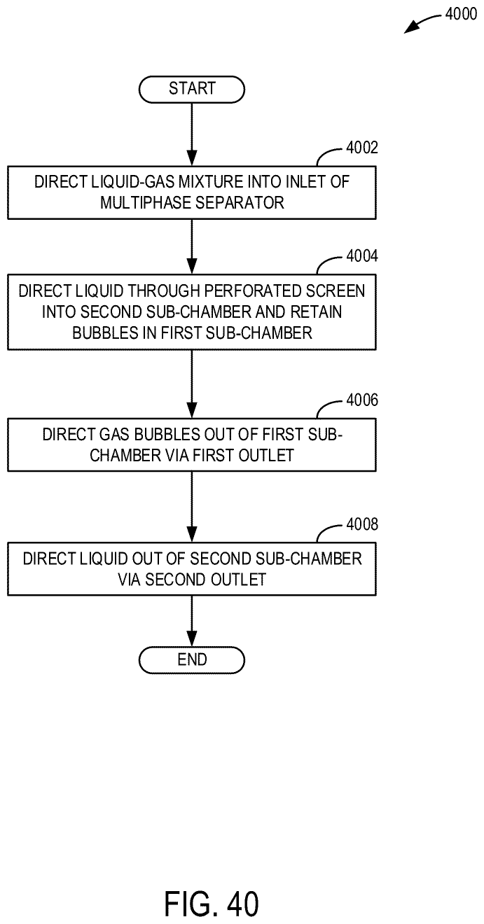

The following description relates to systems and methods for a multiphase gas/bubble diverter with a screening element dividing a chamber into two sub-chambers. The multiphase gas/bubble diverter may be included in a variety of applications for separating and collecting elements of a multiphase fluid (e.g., including a gas and a liquid). A plurality of examples of a multiphase gas/bubble diverter are described herein. Each of the examples of the multiphase gas/bubble diverter described herein include a chamber having an inlet at a first end, and a first outlet and a second outlet at a second end opposite the first end. A screening element extends at least partially from the second end to the first end along a length of the chamber. The screening element at least partially divides the chamber into a first sub-chamber extending between the inlet and the first outlet and a second sub-chamber extending between the first end, not including the inlet, and the second outlet. FIGS. 1-8 show views of a first example multiphase gas/bubble diverter, where the first sub-chamber and the second sub-chamber have teardrop cross-sections. The first sub-chamber and the second sub-chamber are mirrored with respect to each other across a central axis. FIGS. 9-16 show views of a second example multiphase gas/bubble diverter, where the chamber has a teardrop cross-section and a volume of the second sub-chamber is less than a volume of the first sub-chamber. FIGS. 17-22 show views of a third example multiphase gas/bubble diverter, where a height of the first sub-chamber is equal along a length of the first sub-chamber, and a height of the second sub-chamber increases from the first end to the second end. FIGS. 23-27 show views of a fourth example multiphase gas/bubble diverter, where the screening element may be positioned at different angles, with respect to a central axis, and the first outlet and the second outlet may have the same or a different diameter. FIGS. 28-33 show views of a fifth example multiphase gas/bubble diverter, wherein the screening element is a porous splitter that extends a portion of the length of the chamber. FIGS. 34-38 show views of a sixth example multiphase gas/bubble diverter, where the first sub-chamber and the second sub-chamber collectively have an exclamation point cross section. The first sub-chamber has a teardrop cross-section and the second sub-chamber has a circular cross-section. FIG. 39 shows multiphase separating system including the second example multiphase gas/bubble diverter of FIGS. 9-16, for exemplary purposes. Any of the example multiphase gas/bubble diverters of FIGS. 1-38 may be included in the multiphase separating system. FIG. 40 shows a flow chart of a method for multiphase separation using one or more of the example multiphase gas/bubble diverters of FIGS. 1-37. FIGS. 1-38 are shown approximately to scale.

Low-gravity fluid phase separation presents a challenging task due to the absence of significant buoyancy/settling forces and dominance of surface tension forces. Degradation of a fluid system may occur if multiphase flows are inadequately managed. For example, bubble occlusions can shut down system flow paths, undesired multiphase conditions can accelerate erosion of rotating fluid machinery, and free surface bubble coalescence can produce spurious droplet ejections resulting in fluid mass loss. For certain applications, high content liquids or gases (e.g., 100% liquid) are desired for system function (e.g., sensors, thermal devices, dosing systems, and so on). In certain instances, 100% liquid is desired to be provided despite knowledge of the two-phase nature of the source flow. In such cases a diverter (e.g., the multiphase gas/bubble diverter) separates and routes 100% liquid to a target device while a two-phase flow is bypassed around the target device—the flow re-combining downstream of the target device.

The disclosed invention pertains to the design of passive multiphase gas/bubble diverters which exploit wetting characteristics, geometry, fluid properties, and flow characteristics to selectively divert gas and liquid in desired ratios to desired exit out-lines. The invention targets preconditioning of multiphase flow conditions for enhanced processing in downstream systems. In general, the invention employs tapering cross-sectional geometry, referred to here as a ‘tapering teardrop’, to promote preferential gas and liquid phase separation in the crossflow direction along the test cell. The tapering teardrop geometry, wye fitting axial length, and outlet port lateral separation distance are specified (calculated) according to operational flow rates and flow regimes of the application inclusive of the downstream tubing and boundary conditions. A flow splitter assists in preferential gas phase diversion. A degree of specified splitter asymmetry determines the balance between operational profile (e.g., flow rates and inlet conditions) and outline pressure drop balance. A porous or otherwise liquid permeable splitter is employed to rebalance pressure drop distribution while maintaining operational profile.

Pre-conditioning of flow phase ratios assists in downstream phase separation operations. Undesirable flow regimes and inlet conditions may be transformed into optimal conditions for essentially 100% phase separation. Such phase conditioning bolsters system performance over broad flow rates and regimes without introducing complex electrical or mechanical devices. The specific bias angles, distances between a first outlet and a second outlet, widths, and lengths of the device are fluid mechanical functions of the flow rate, absolute pressure, and downstream pressure losses (flow resistances) of the liquid and gas exit lines. For flow rates between >0 ml/s to 10 ml/s, balanced flow losses downstream with approximately 100% liquid separation may be achieved with bias angles between 0 degrees and 45 degrees. Passage lengths may be between 2 cm and 20 cm. A lateral distance between the first outlet and the second outlet may be between 0.5 cm to 10 cm. For greater flow rates, larger dimensions may be used for one or more of the bias angles, passage lengths, and lateral distance.

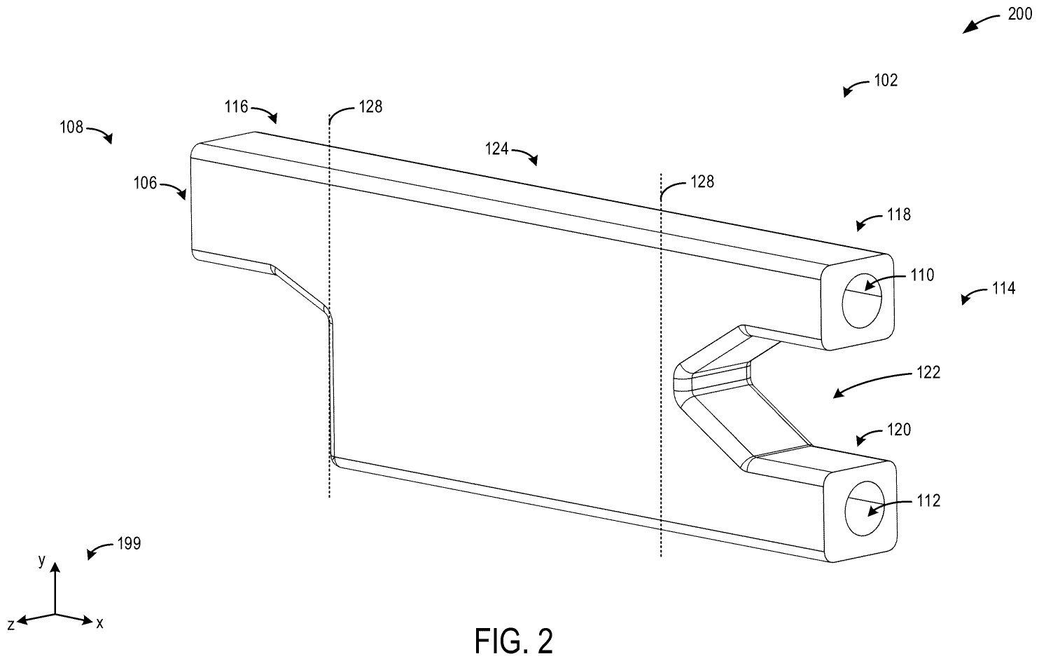

FIG. 1 shows a first perspective view 100 of a first multiphase gas/bubble diverter 102. FIG. 2 shows a second perspective view 200 of the first multiphase gas/bubble diverter 102. FIGS. 1-2 are described simultaneously herein. Reference axes 199 are included in FIGS. 1-8 in order to compare the views and relative orientations described herein. Reference axes 199 includes three axes, namely an x-axis, a y-axis, and a z-axis. A positive direction for each axis is indicated by an arrow and/or a filled in circle.

The first multiphase gas/bubble diverter 102 comprises an inlet 106 at a first end 108, and a first outlet 110 and a second outlet 112 at a second end 114 opposite the first end 108. The first multiphase gas/bubble diverter 102 is formed of a single, monolithic body with chambers, sub-chambers, and a screening element for separating liquid and gas from a liquid-gas mixture into the sub-chambers. In this way, gas may be output via the first outlet 110 and liquid may be output via the second outlet 112. The single, monolithic body may have a rectangular body 124 with a first extension 116 at the first end 108 for the inlet 106. A second extension 118 and a third extension 120 each extend from the second end 114 of the rectangular body 124 for the first outlet 110 and the second outlet 112, respectively. The rectangular body 124, the first extension 116, and the second extension 118 and the third extension 120 are delineated by dashed lines 128, for illustrative purposes. The second extension 118 and the third extension 120 may have a gap 122 therebetween, such as a v-shaped space, as shown in FIGS. 1-2.

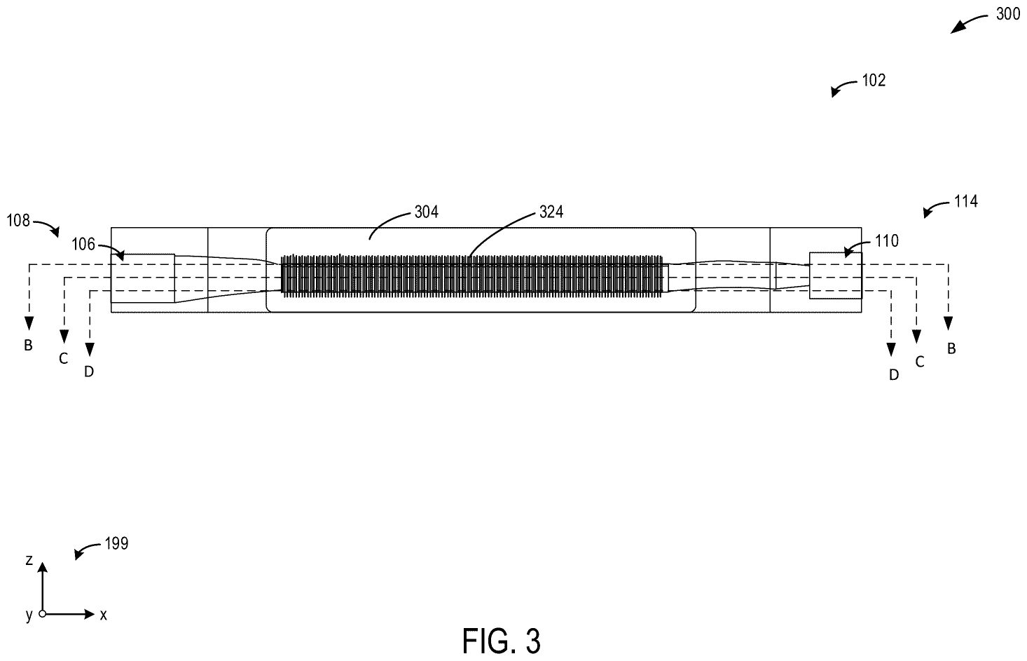

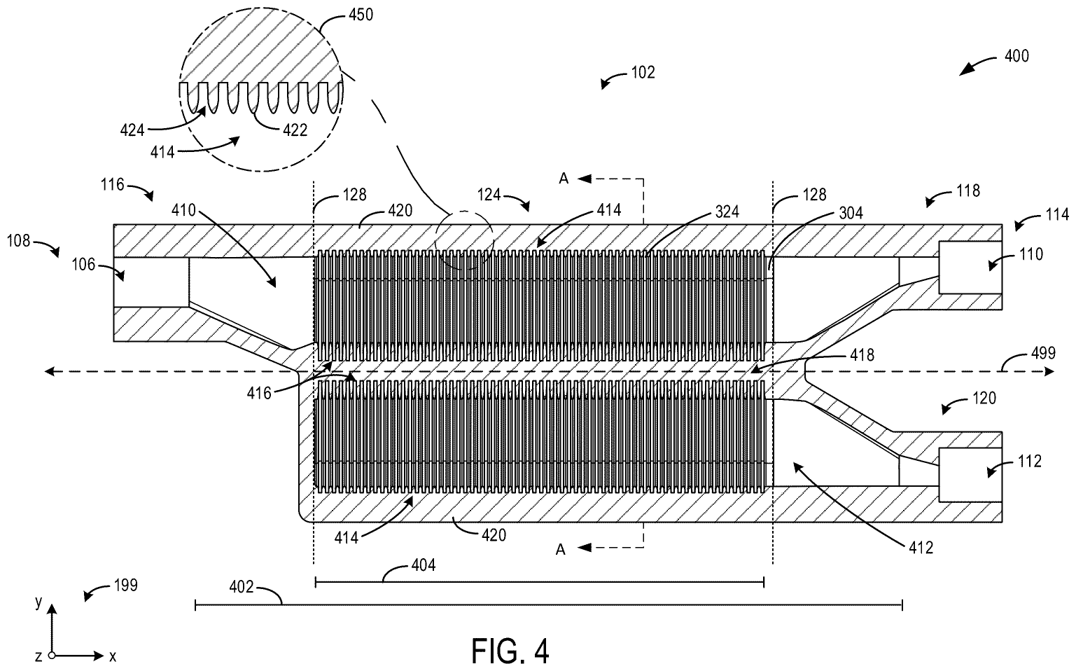

FIG. 3 shows a top-down view 300 of the first multiphase gas/bubble diverter 102. The first multiphase gas/bubble diverter 102 is shown as partially transparent in FIG. 3 so as to illustrate internal components of the first multiphase gas/bubble diverter 102. The top-down view 300 shows the inlet 106, a chamber 304, and the first outlet 110. A screening element 324 is positioned in the chamber 304. As further described with respect to FIGS. 4-8, the screening element 324 is configured to selectively fluidly couple the inlet 106 to the first outlet 110 and the second outlet (not shown).

FIG. 4 shows a first cross-sectioned side view 400 of the first multiphase gas/bubble diverter 102. The first multiphase gas/bubble diverter 102 is sectioned along a line C-C of FIG. 3. The second end 114 is opposite and distanced from the first end 108 by a length 402 of the chamber 304. The screening element 324 extends at least partially along the length 402 of the chamber 304. For example, the screening element 324 is positioned in the rectangular body 124. The screening element 324 extends a first portion 404 of the length 402 of the chamber 304. The length 402 of the chamber 304 and/or the first portion 404 of the length 402 that the screening element 324 extends along may be varied at achieve liquid-gas separation at different flow rates. For example, for flow rates between >0 ml/s and 10 ml/s, the length 402 of the chamber 304 may be between 2 cm and 20 cm.

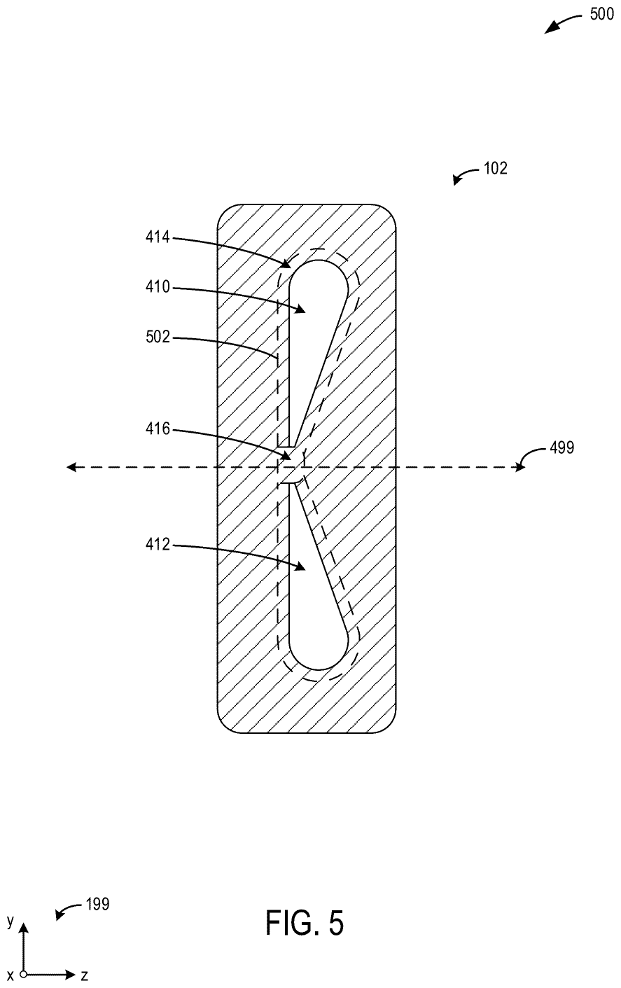

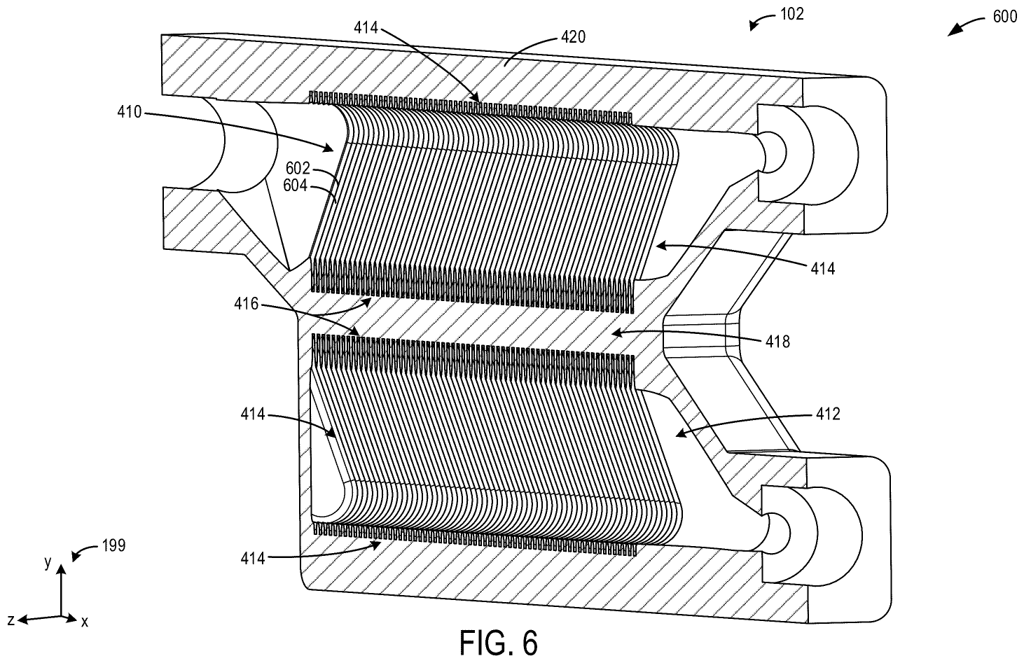

The chamber 304 is at least partially divided into two sub-chambers by the screening element 324. A first sub-chamber 410 extends between the inlet 106 and the first outlet 110 (e.g., includes the first extension 116, the second extension 118, and a portion of the rectangular body 124 therebetween). A second sub-chamber 412 extends between the first end 108 and the second outlet 112 (e.g., the third extension 120 and a portion of the rectangular body 124 between the first end 108 and the third extension 120). The second sub-chamber 412 does not include the inlet 106. Excluding volume of the first extension 116, the second extension 118, and the third extension 120, the first sub-chamber 410 and the second sub-chamber 412 may have the same volume. The first sub-chamber 410 and the second sub-chamber 412 may each have a teardrop cross-section, as further described with respect to FIGS. 5-6. At least a portion of internal walls 420 of the first multiphase gas/bubble diverter 102 extends between the first sub-chamber 410 and the second sub-chamber 412 at an intersection 418. At the intersection 418, the first sub-chamber 410 and the second sub-chamber 412 may be partially and selectively fluidly coupled by the screening element 324.

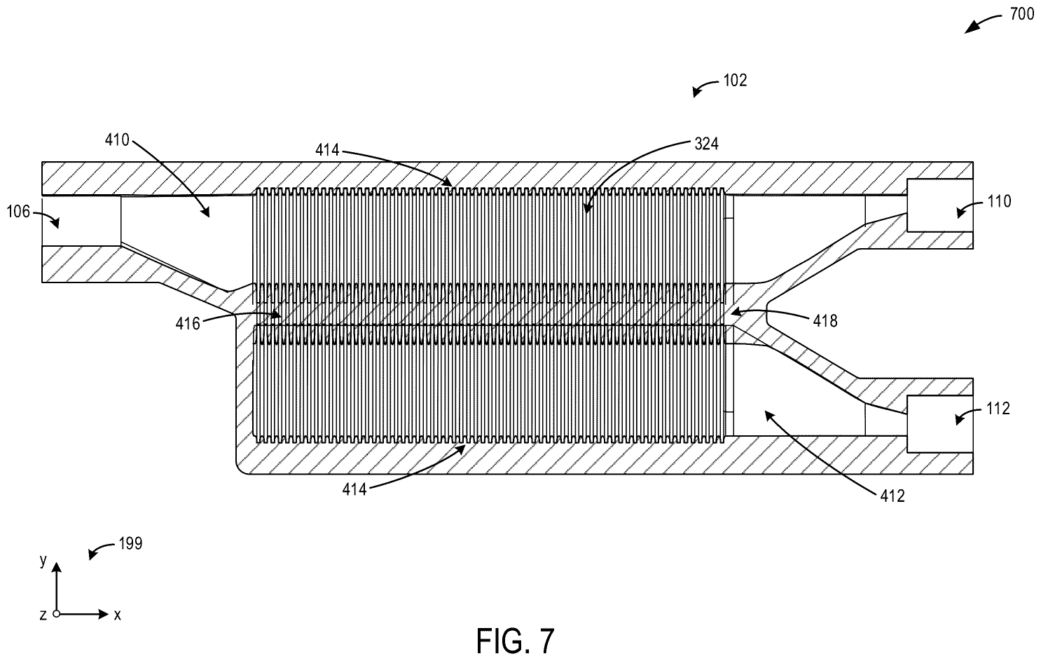

The screening element 324 is formed of an alternating series of screen material and gaps therebetween. The screening element 324 is configured to wick liquid from the first sub-chamber 410 to the second sub-chamber 412 and block transmission of gas (e.g., gas bubbles) from the first sub-chamber 410 to the second sub-chamber 412. Gaps between the screen material form bubble point flow channels 416 and cusp channels 414. The bubble point flow channels 416 span the intersection 418 between the first sub-chamber 410 and the second sub-chamber 412. This spanning is not shown in the view 400 of FIG. 4 due to a position of the sectioning plane, and is shown in further detail in FIGS. 5 and 7. The cusp channels 414 may extend into internal walls 420 of the first multiphase gas/bubble diverter 102. The cusp channels 414 are shown in further detail in a view 450 of FIG. 4. The cusp channels 414 have villi-like structures which extend along internal walls 420 of the chamber 304. For example, the cusp channels 414 may extend along the first sub-chamber 410 and the second sub-chamber 412. Described another way, the cusp channels 414 are formed of a series of projections 422 from the internal walls 420 of the first sub-chamber 410 and the second sub-chamber 412 towards a center (e.g., depicted by a central axis 499) of the first multiphase gas/bubble diverter 102. Cavities 424 are formed between each of the series of projections 422. The cusp channels 414 thus increase a surface area of the chamber 304 and increase a geometry wettability of the first multiphase gas/bubble diverter 102, compared to wetting abilities of multiphase gas/bubble diverters without cusp channels, e.g., where walls of sub-chambers are continuous without projections and/or cavities that increase wall surface area. For example, the cusp channels 414 may make the chamber 304 of the first multiphase gas/bubble diverter 102 perfectly wetting (e.g., an effectively zero contact angle is formed between liquid and the cusp channels 414). The projections 422 may be equally sized and spaced. The cavities 424 may have the same depth that extends into the internal walls 420. Cusp channels 414 may be included on all internal walls 420 of the first multiphase gas/bubble diverter 102 in the first sub-chamber 410 and the second sub-chamber 412, as further shown in FIGS. 5-6.

Turning to FIG. 5, a cross-sectioned end view 500 of the first multiphase gas/bubble diverter 102 is shown. The first multiphase gas/bubble diverter 102 is sectioned along a line A-A of FIG. 4. The first multiphase gas/bubble diverter 102 may have a rectangular cross-section. The first sub-chamber 410 and the second sub-chamber 412 have teardrop cross-sections. The first sub-chamber 410 and the second sub-chamber 412 are mirrored with respect to each other across the central axis 499 (e.g., across the z-axis). A dashed line 502 illustrates cusp channels 414 and bubble point flow channels 416 of the screening element 324, as described with respect to FIG. 4. The screening element 324 extends across the intersection 418 (e.g., between the first sub-chamber 410 and the second sub-chamber 412. The bubble point flow channels 416 span the intersection 418 between the first sub-chamber 410 and the second sub-chamber 412. The first sub-chamber 410 and the second sub-chamber 412 may not be directly coupled; there is a portion of the internal wall 420 separating the first sub-chamber 410 and the second sub-chamber 412. The bubble point flow channels 416 of the screening element 324 enable selective fluidic communication between the first sub-chamber 410 and the second sub-chamber 412. Liquid is wicked into the cusp channels 414, which are continuous around a perimeter of the first sub-chamber 410 and the second sub-chamber 412 as illustrated by the dashed line 502, and is deposited into the second sub-chamber 412. Liquid may also be directed from cusp channels 414 into the bubble point flow channels 416, and thus from the first sub-chamber 410 to the second sub-chamber 412.

FIG. 6 shows a cross-sectioned perspective view 600 of the first multiphase gas/bubble diverter 102. The first multiphase gas/bubble diverter 102 is sectioned along a line C-C of FIG. 3. FIG. 6 shows a partial view of the teardrop cross-sections of the first sub-chamber 410 and the second sub-chamber 412. FIG. 6 further illustrates the alternating series of screen material 602 and gaps 604 of the screening element 324. The cusp channels 414 extend radially into the internal walls 420 of the first sub-chamber 410 and the second sub-chamber 412. Spanning of the bubble point flow channels 416 across the intersection 418 between the first sub-chamber 410 and the second sub-chamber 412 is not shown in the view 600 of FIG. 6 due to a position of the sectioning plane.

FIG. 7 shows a second cross-sectioned side view 700 of the first multiphase gas/bubble diverter 102. The first multiphase gas/bubble diverter 102 is sectioned along a line D-D of FIG. 3. The bubble point flow channels 416 span the intersection 418 between the first sub-chamber 410 and the second sub-chamber 412. A liquid-gas mixture flows into the first multiphase gas/bubble diverter 102 via the inlet 106. The liquid-gas mixture flows through the chamber 304 and into the first sub-chamber 410. The screening element 324 wicks liquid through the bubble point flow channels 416 thereof and into the second sub-chamber 412. The cusp channels 414 may assist in driving the liquid-gas mixture from the inlet 106 towards the screening element 324 while also assisting in occluding gas bubbles from going through the screening element 324. In this way, gas bubbles may remain in the first sub-chamber 410 while liquid passes through the screening element 324 into the second sub-chamber 412. Liquid may flow out of the second outlet 112. Gas, and/or gas and liquid, may flow out of the first outlet 110.

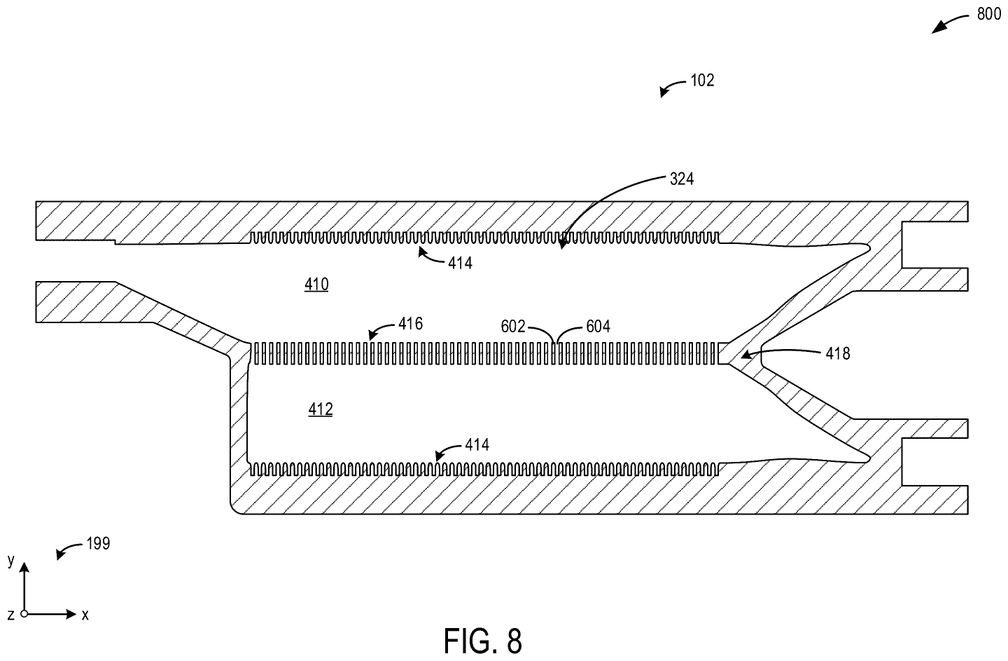

FIG. 8 shows a third cross-sectioned side view 800 of the first multiphase gas/bubble diverter 102. The first multiphase gas/bubble diverter 102 is sectioned along a line B-B of FIG. 3. The view 800 shows the bubble point flow channels 416 that span the intersection 418 between the first sub-chamber 410 and the second sub-chamber 412. The screening element 324 forms the bubble point flow channels 416 from the alternating series of screen material 602 and gaps 604.

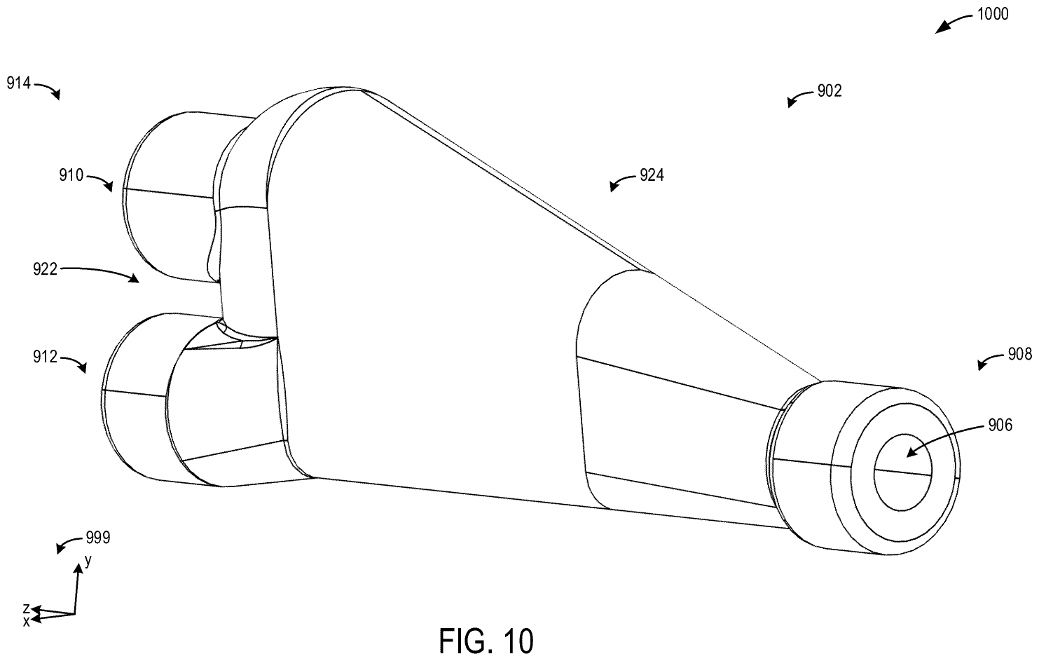

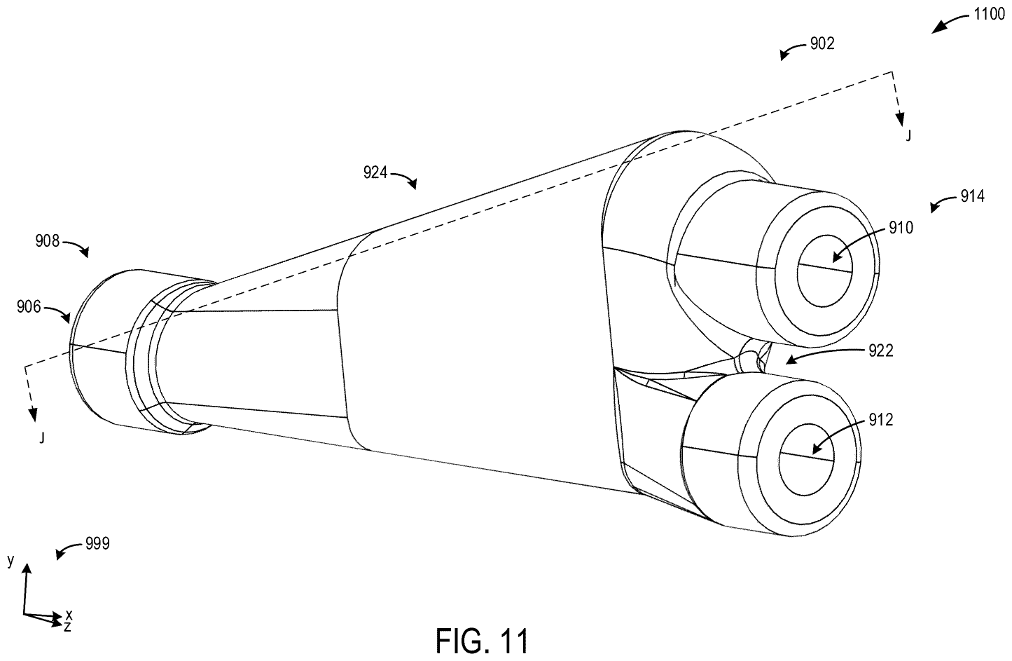

FIG. 9 shows a first side view 900 of a second multiphase gas/bubble diverter 902. FIG. 10 shows a first perspective view 1000 of the second multiphase gas/bubble diverter 902. FIG. 11 shows a second perspective view 1100 of the second multiphase gas/bubble diverter 902. FIGS. 9-11 are described simultaneously herein. Reference axes 999 are included in FIGS. 9-16 in order to compare the views and relative orientations described herein. Reference axes 999 includes three axes, namely an x-axis, a y-axis, and a z-axis. A positive direction for each axis is indicated by an arrow and/or a filled in circle.

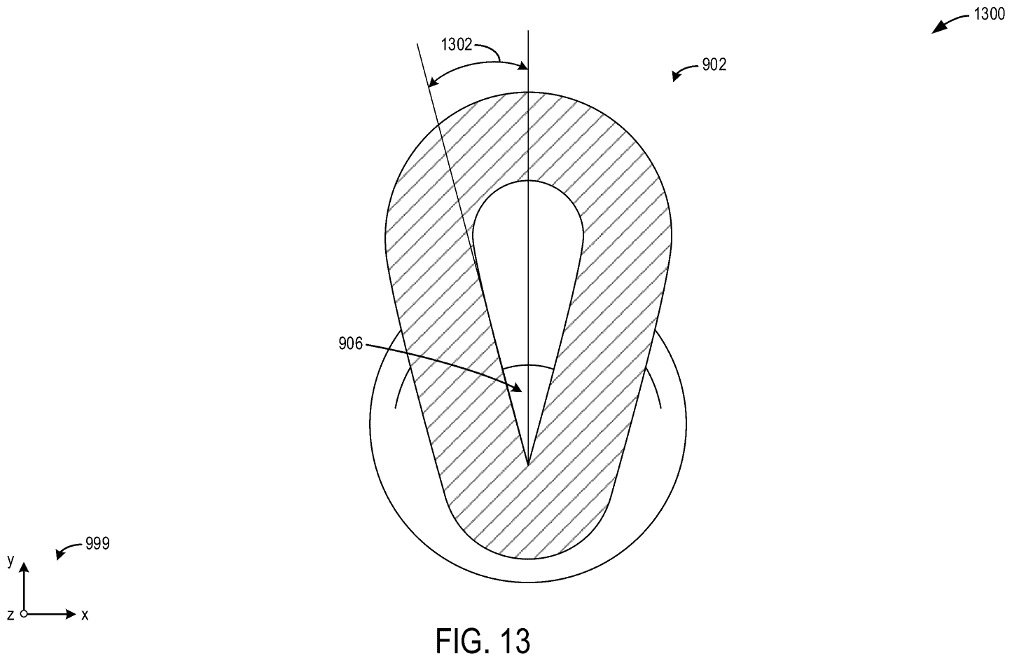

The second multiphase gas/bubble diverter 902 comprises a body 924 with an inlet 906 at a first end 908, and a first outlet 910 and a second outlet 912 at a second end 914 that is opposite the first end 908. The second end 914 is opposite and distanced from the first end 908 by a length 920 of the body 924. One or more of the inlet 906, the first outlet 910, and the second outlet 912 may have a circular cross-section. The second multiphase gas/bubble diverter 902 is formed of a single, monolithic body with chambers, sub-chambers, and a screening element for separating liquid and gas from a liquid-gas mixture into the sub-chambers. In this way, gas and/or gas and liquid may be output via the first outlet 910 and liquid may be output via the second outlet 912. The body 924 may have a first height 916 at the first end 908, and a height of the body 924 gradually increases along the length 920 of the body 924 to a second height 918 at the second end 914 where the second height 918 is greater than the first height 916. As further described with respect to FIGS. 13-15, the body 924 may have a teardrop cross-section. The first outlet 910 and the second outlet 912 may have a gap 922 therebetween, such as a u-shaped space.

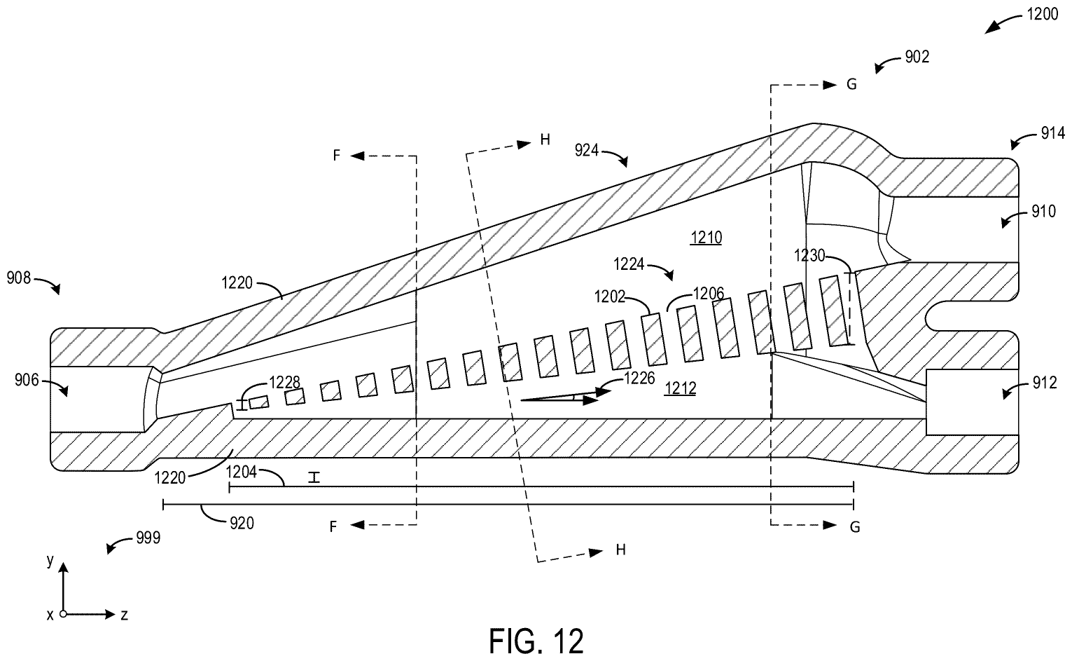

FIG. 12 shows a first cross-sectioned side view 1200 of the second multiphase gas/bubble diverter 902. The second multiphase gas/bubble diverter 902 is sectioned along a line E-E of FIG. 9. A screening element 1224 extends at least partially along the length 920 of the body 924. For example, the screening element 1224 may extend a first portion 1204 of the length 920 of the chamber 304. The length 920 of the body 924 and/or the first portion 1204 of the length 920 that the screening element 1224 extends along may be varied to achieve liquid-gas separation at different flow rates. For example, for flow rates between >0 ml/s and 10 ml/s, the length 920 of the chamber 304 may be between 2 cm and 20 cm.

The second multiphase gas/bubble diverter 902 is at least partially divided into two sub-chambers by the screening element 1224. A first sub-chamber 1210 extends between the inlet 906 and the first outlet 910. A second sub-chamber 1212 extends between internal walls 1220 of the second multiphase gas/bubble diverter 902 at the first end 908, and the second outlet 912. The second sub-chamber 1212 does not include the inlet 906. The screening element 1224 may be coupled to the internal wall 1220 at the second end 914 of the second multiphase gas/bubble diverter 902 between the first outlet 910 and the second outlet 912. The screening element 1224 may further be coupled to the internal wall 1220 of the second multiphase gas/bubble diverter 902 at the first end 908. The screening element 1224 comprises an alternating series of screen material 1202 and gaps 1206 of the screening element 1224. The screen material 1202 may be, for example, the same material which forms the internal walls 1220 of the second multiphase gas/bubble diverter 902. In other examples, the screen material 1202 is formed of a different material than that forming the internal walls 1220.

The screening element 1224 is positioned at a bias angle 1226 with respect to the z-axis of the reference axes 999. The bias angle 1226 may be configured based on an operational flow rate of the second multiphase gas/bubble diverter 902. For example, the screening element 1224 may be positioned at a larger bias angle 1226 in an embodiment of the second multiphase gas/bubble diverter 902 configured to separate multiphase flows at higher flow rates, compared to an embodiment of the second multiphase gas/bubble diverter 902 configured to separate multiphase flows at lower flow rates. For flow rates between >0 ml/s to 10 ml/s, the bias angle 1226 may be between 0 degrees and 45 degrees to enable liquid-gas separation. The screening element is positioned at a bias angle in a horizontal plane, with respect to the vertical plane, such that a cross-section of the first sub-chamber taken along the vertical plane has a different geometry compared to a cross-section of the second sub-chamber taken along the vertical plane. The first sub-chamber 1210 and the second sub-chamber 1212 may have asymmetric geometries. A volume of the first sub-chamber 1210 may be greater than a volume of the second sub-chamber 1212.

A height of the screening element 1224 may gradually increase from the first end 908 to the second end 914. For example, the screening element 1224 has a first height 1228 at the first end 908 and a second height 1230 at the second end 914, the second height 1230 greater than the first height 1228. A gap width (e.g., distance between pieces of screen material 1202) may be equal to a width of the screen material 1202, with respect to the z-axis, in some examples. In other examples, the gap width may be greater than or less than the width of the screen material width.

The screening element 1224 enables selective fluid communication between the first sub-chamber 1210 and the second sub-chamber 1212. Gaps between the screen material span an interface between the first sub-chamber 1210 and the second sub-chamber 1212. Liquid is drawn through the screening element 1224 from the first sub-chamber 1210 to the second sub-chamber 1212. Gaseous bubbles are retained in the first sub-chamber 1210.

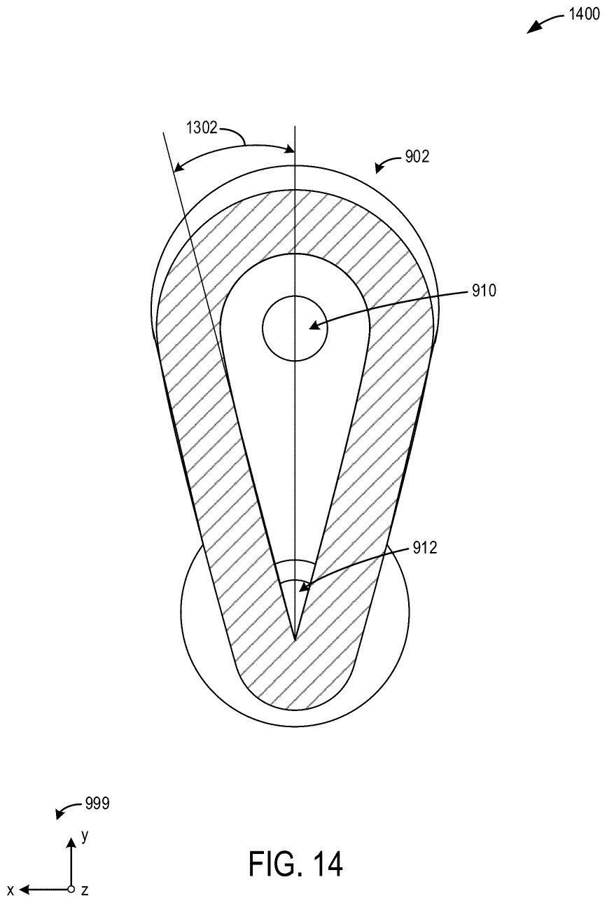

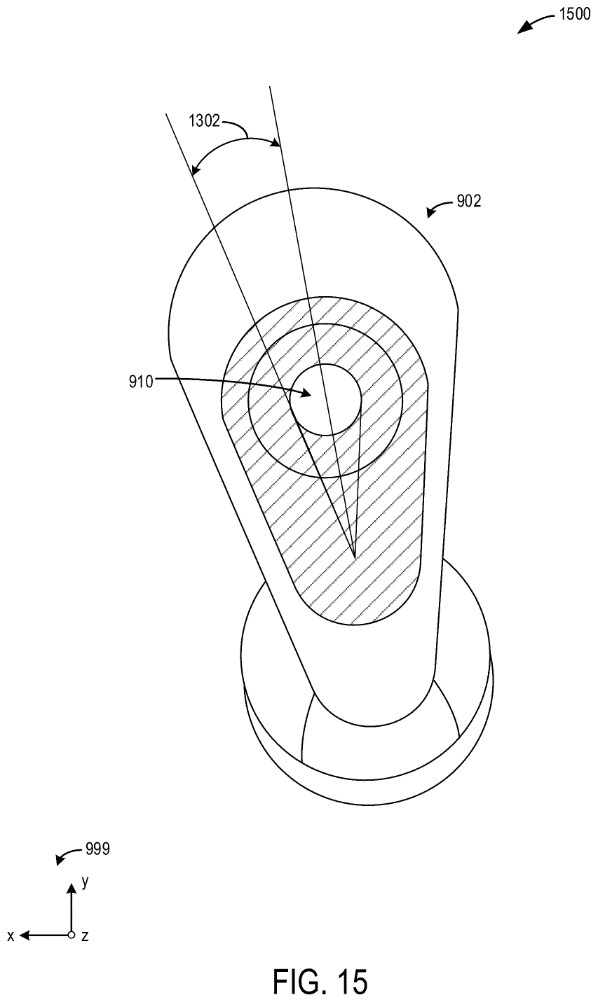

FIGS. 13, 14, and 15 show cross-sectioned end views of the second multiphase gas/bubble diverter 902, and are discussed simultaneously herein. FIG. 13 shows a first cross-sectioned end view 1300, including a partial view of the inlet 906. In the view of FIG. 13, the second multiphase gas/bubble diverter 902 is sectioned along a line F-F of FIG. 12. The view of FIG. 13 looks from the second end 914 towards the first end 908. FIG. 14 shows a second cross-sectioned end view 1400, including a partial view of the first outlet 910 and the second outlet 912. In the view of FIG. 14, the second multiphase gas/bubble diverter 902 is sectioned along a line G-G of FIG. 12. The view of FIG. 14 looks from the first end 908 towards the second end 914. FIG. 15 shows a third cross-sectioned end view 1500, including a partial view of the first outlet 910. In the view of FIG. 15, the second multiphase gas/bubble diverter 902 is sectioned along a line H-H of FIG. 12. The view of FIG. 15 looks from the first end 908 towards the second end 914.

The second multiphase gas/bubble diverter 902 may be symmetric with respect to the y-axis. The second multiphase gas/bubble diverter 902 may have a teardrop cross-section with tapering geometry. The teardrop cross-section includes a corner half-angle 1302 which may be the same along the length 920 of the body 924 of the second multiphase gas/bubble diverter 902.

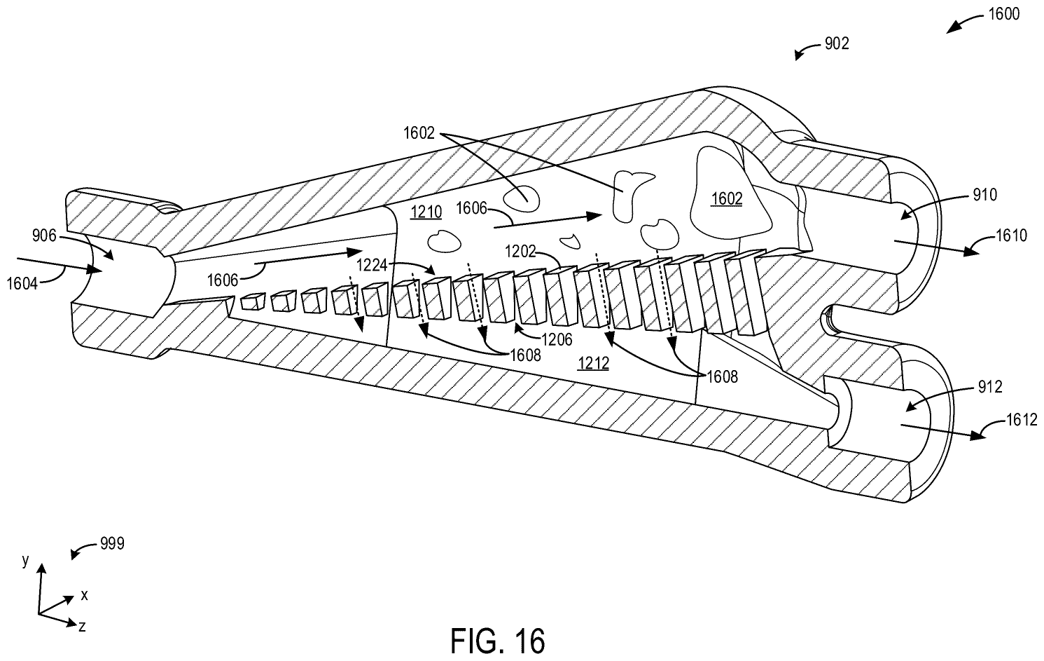

Turning to FIG. 16, a cross-sectioned perspective view 1600 is shown of the second multiphase gas/bubble diverter 902. In the view of FIG. 16, the second multiphase gas/bubble diverter 902 is sectioned along a line J-J of FIG. 11. The bubble point flow channels 416 of the screening element 1224 span the interface between the first sub-chamber 1210 and the second sub-chamber 1212. A liquid-gas mixture flows into the second multiphase gas/bubble diverter 902 via the inlet 906, as indicated by a first arrow 1604. The liquid-gas mixture flows into the first sub-chamber 1210, as illustrated by a second arrow 1606. The screening element 1224 wicks liquid through the bubble point flow channels 416 thereof and into the second sub-chamber 1212, as illustrated by dashed arrows 1608. Gas bubbles 1602 are occluded from going through the screening element 1224. In this way, gas bubbles may remain in the first sub-chamber 1210 while liquid passes through the screening element 1224 into the second sub-chamber 1212. Gas may flow out of the first outlet 910 as illustrated by a fourth arrow 1610. Liquid may flow out of the second outlet 912 as illustrated by a fifth arrow 1612. In this way, the second multiphase gas/bubble diverter 902 of FIGS. 9-16 may exploit passive capillary fluidic phenomena using wetting phenomena, geometry, and fluid properties to separate a two-phase flow by directing gaseous bubbles away from a screening element and passing liquid through the screening element. The tapering teardrop geometry includes the corner half-angle, the axial length, and the lateral distance between the first outlet and the second outlet, which may be configurable based on an operational flow rate, thus enabling separation of liquid and gas flows from a multiphase flow across a range of flow rates.

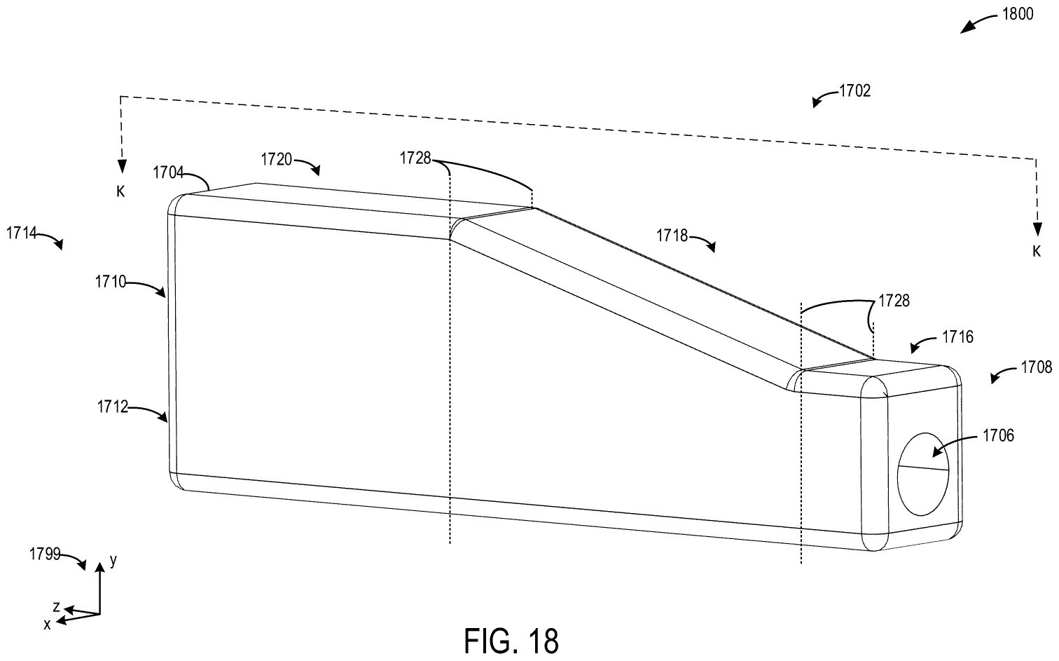

FIG. 17 shows a first perspective view 1700 of a third multiphase gas/bubble diverter 1702. FIG. 18 shows a second perspective view 1800 of the third multiphase gas/bubble diverter 1702. FIGS. 17-18 are described simultaneously herein. Reference axes 1799 are included in FIGS. 17-22 in order to compare the views and relative orientations described herein. Reference axes 1799 includes three axes, namely an x-axis, a y-axis, and a z-axis. A positive direction for each axis is indicated by an arrow and/or a filled in circle.

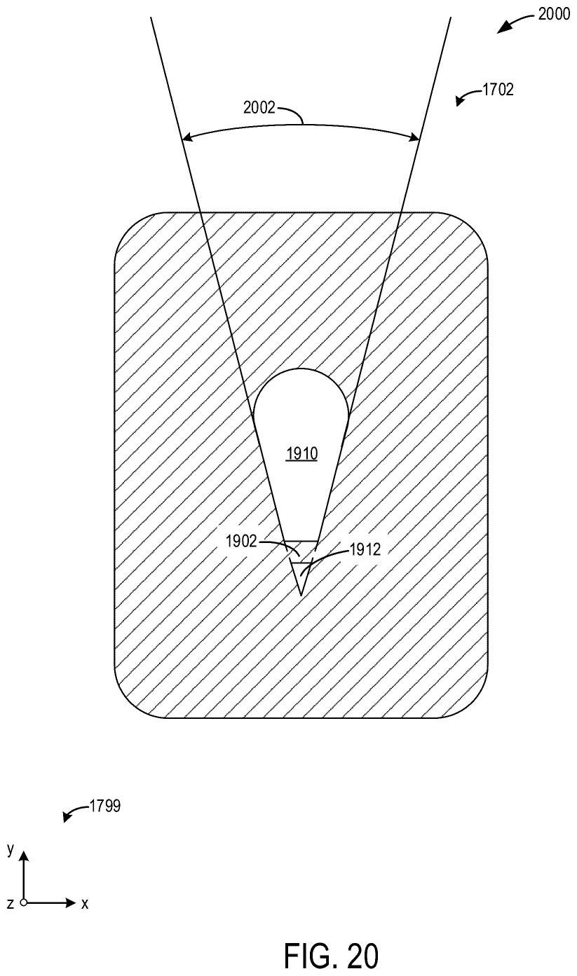

The third multiphase gas/bubble diverter 1702 comprises a body 1704 with an inlet 1706 at a first end 1708, and a first outlet 1710 and a second outlet 1712 at a second end 1714 opposite the first end 1708. The inlet 1706 may have a circular cross-section. The first outlet 1710 may have a circular cross-section. The second outlet 1712 may have a circular cross-section. A diameter of the inlet 1706 may be equal to a diameter of one or both of the first outlet 1710 and the second outlet 1712. The third multiphase gas/bubble diverter 1702 is formed of a single, monolithic body with chambers, sub-chambers, and a screening element for separating liquid and gas from a liquid-gas mixture into the sub-chambers. In this way, gas may be output via the first outlet 1710 and liquid may be output via the second outlet 1712. The body 1704 may have a rectangular cross-section in the y-x plane, as further described with respect to FIGS. 20-22. The body 1704 comprises a first region 1716 with a rectangular cross-section. The first region 1716 has a first height 1722. The body 1704 further comprises a second region 1718 that is continuous with the first region 1716. The second region 1718 has a first side 1734 that is planar and parallel to the z-x plane. The second region 1718 further has a second side 1732, opposite the first side 1734, that is sloped with respect to the z-x plane. The body 1704 comprises a third region 1720 that is continuous with the second region 1718, opposite the first region 1716. The third region 1720 has a second height 1724. The second height may be greater than the first height 1722. A height (e.g., parallel to the y-axis) of the second region 1718 gradually increases from the first height 1722 of the first region 1716 to the second height 1724 of the third region 1720 along a length 1730 of the second region 1718. The first region 1716, the second region 1718, and the third region 1720 of the body are delineated by dashed lines 1728, for illustrative purposes.

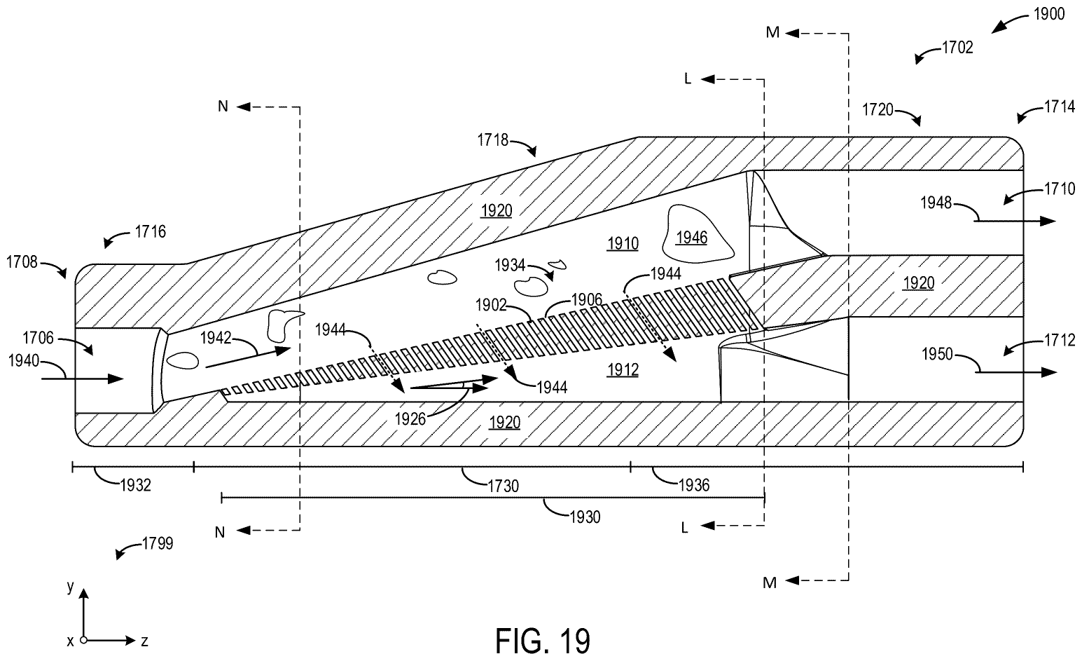

FIG. 19 shows a first cross-sectioned side view 1900 of the third multiphase gas/bubble diverter 1702. The third multiphase gas/bubble diverter 1702 is sectioned along a line K-K of FIGS. 17-18. A screening element 1934 is at least partially positioned in the first region 1716 and the second region 1718. The screening element 1934 is configured to selectively fluidly couple the inlet 1706 to the first outlet 1710 and the second outlet 1712. One or more of the length 1730 of the second region 1718, a first length 1932 of the first region 1716, a third length 1936 of the third region 1720, and/or a screen length 1930 of the screening element 1934 may be varied at achieve liquid-gas separation at different flow rates. For example, for flow rates between >0 ml/s and 10 ml/s, the length 1730 of the second region 1718 may be between 2 cm and 20 cm.

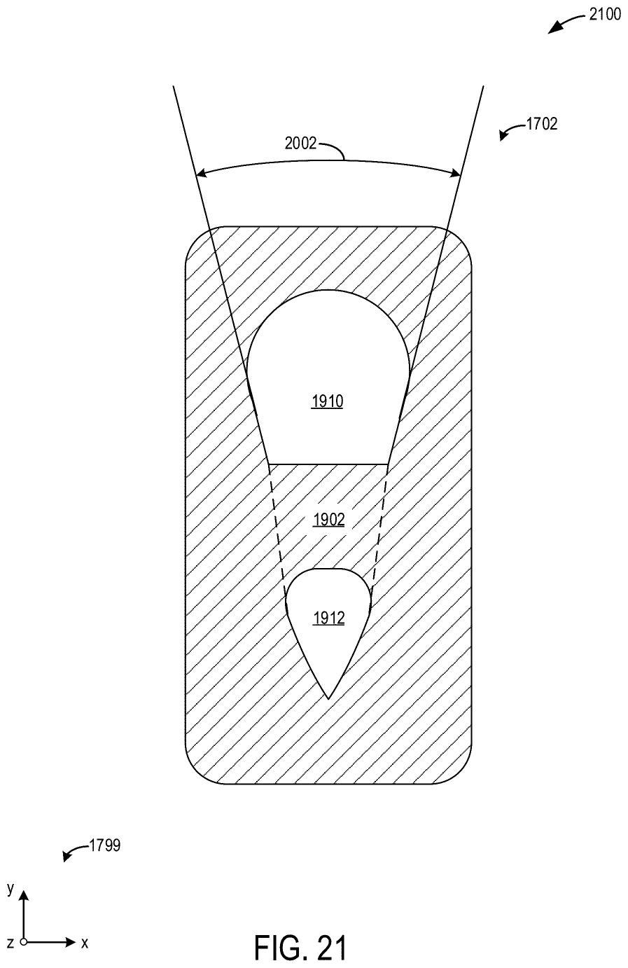

The third multiphase gas/bubble diverter 1702 is at least partially divided into two sub-chambers by the screening element 1934. A first sub-chamber 1910 extends between the inlet 1706 and the first outlet 1710. A second sub-chamber 1912 extends between the first end 1708 and the second outlet 1712. The second sub-chamber 1912 does not include the inlet 1706. One or more of the first sub-chamber 1910 and the second sub-chamber 1912 may have a teardrop cross-section, as further described with respect to FIGS. 20-21. For example, the circular cross-section of the inlet 1706 may transition to the teardrop cross-section of the first sub-chamber 1910 at an intersection between the first region 1716 and the second region 1718. The teardrop cross-section of the first sub-chamber 1910 may transition to the circular cross-section of the first outlet 1710 at an intersection between the second region 1718 and the third region 1720. The teardrop cross-section of the second sub-chamber 1912 may transition to the circular cross-section of the second outlet 1712 at the intersection between the second region 1718 and the third region 1720. The first sub-chamber 1910 and the second sub-chamber 1912 may have asymmetric geometries. A volume of the first sub-chamber 1910 may be greater than a volume of the second sub-chamber 1912.

The screening element 1934 is formed of an alternating series of screen material 1902 and gaps 1906 therebetween. The screening element 1934 is configured to wick liquid from the first sub-chamber 1910 to the second sub-chamber 1912 and block transmission of gas (e.g., gas bubbles) from the first sub-chamber 1910 to the second sub-chamber 1912. The screen material 1902 may be, for example, the same material which forms the internal walls 1920 of the third multiphase gas/bubble diverter 1702. In other examples, the screen material 1902 is formed of a different material than that forming the internal walls 1920. Gaps 1906 between the screen material 1902 may form bubble point flow channels.

The screening element 1934 may extend from and/or be coupled to an internal wall 1920 of the third multiphase gas/bubble diverter 1702 at the second end 1714. The internal wall 1920 may extend between the first outlet 1710 and the second outlet 1712 in the third region 1720, such that there is no gap (e.g., air-filled space) between the first outlet 1710 and the second outlet 1712. The screening element 1934 may further be coupled to the internal wall 1920 of the third multiphase gas/bubble diverter 1702 at the first end 1708. The screening element 1934 is positioned at a bias angle 1926 with respect to the z-axis of the reference axes 1799. The bias angle 1926 may be configured based on an operational flow rate of the third multiphase gas/bubble diverter 1702. For example, the screening element 1934 may be positioned at a larger bias angle 1926 in an embodiment of the third multiphase gas/bubble diverter 1702 configured to separate multiphase flows at higher flow rates, compared to an embodiment of the third multiphase gas/bubble diverter 1702 configured to separate multiphase flows at lower flow rates. For flow rates between >0 ml/s to 10 ml/s, the bias angle 1926 may be between 0 degrees and 45 degrees to enable liquid-gas separation.

A height (e.g., parallel to the y-axis) of the screening element 1934 may gradually increase from the first end 1708 to the second end 1714. A gap width (e.g., distance between pieces of screen material 1902) may be equal to a width of the screen material 1902, with respect to the z-axis, in some examples. In other examples, the gap width may be greater than or less than the width of the screen material width.

The screening element 1934 enables selective fluid communication between the first sub-chamber 1910 and the second sub-chamber 1912. Gaps between the screen material span an interface between the first sub-chamber 1910 and the second sub-chamber 1912. A liquid-gas mixture flows into the third multiphase gas/bubble diverter 1702 via the inlet 1706, as indicated by a first arrow 1940. The liquid-gas mixture flows into the first sub-chamber 1910, as illustrated by a second arrow 1942. The screening element 1934 wicks liquid through the gaps 1906 therebetween and into the second sub-chamber 1912, as illustrated by dashed arrows 1944. Gas bubbles 1946 are occluded from going through the screening element 1934. In this way, gas bubbles may remain in the first sub-chamber 1910 while liquid passes through the screening element 1934 into the second sub-chamber 1912. Gas may flow out of the first outlet 1710 as illustrated by a fourth arrow 1948. Liquid may flow out of the second outlet 1712 as illustrated by a fifth arrow 1950.

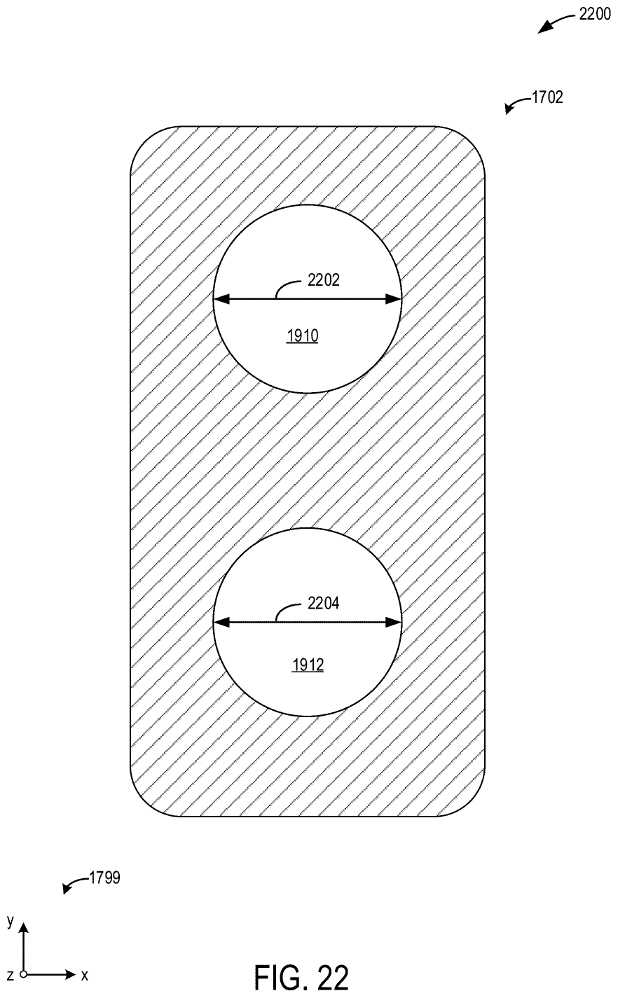

FIGS. 20, 21, and 22 show cross-sectioned end views of the third multiphase gas/bubble diverter 1702, and are discussed simultaneously herein. FIG. 20 shows a first cross-sectioned end view 2000, including a partial view of the first sub-chamber 1910 and the second sub-chamber 1912. In the view of FIG. 20, the third multiphase gas/bubble diverter 1702 is sectioned along a line N-N of FIG. 19. The view of FIG. 20 looks from the second end 914 towards the first end 908. FIG. 21 shows a second cross-sectioned end view 2100, including a partial view of the first sub-chamber 1910 and the second sub-chamber 1912. In the view of FIG. 21, the third multiphase gas/bubble diverter 1702 is sectioned along a line L-L of FIG. 19. The view of FIG. 21 looks from the second end 1714 towards the first end 1708. FIG. 22 shows a third cross-sectioned end view 2200, including a view of the first outlet 1710 and the second outlet 1712. In the view of FIG. 22, the third multiphase gas/bubble diverter 1702 is sectioned along a line M-M of FIG. 12. The view of FIG. 22 looks from the first end 908 towards the second end 914.

The third multiphase gas/bubble diverter 1702 may be symmetric with respect to the y-axis (e.g., the y-z plane). The third multiphase gas/bubble diverter 1702 has a rectangular cross section. The first sub-chamber 1910 and the second sub-chamber 1912 may have a teardrop cross-section with tapering geometry. The teardrop cross-section includes a corner half-angle 2002 which may be the same along the length 1730 of each of the first sub-chamber 1910 and the second sub-chamber 1912. The view 2000 of FIG. 20 is a cross-section taken closer to the first end 1708 of the third multiphase gas/bubble diverter 1702, compared to the view 2100 of FIG. 21. The first sub-chamber 1910 has a greater cross-sectional area than the second sub-chamber 1912 in the view 2000 of FIG. 20 (e.g., closer to the first end 1708). Continuing along the length 1730 of the second region 1718, and as shown in FIG. 21, a cross-sectional area of the second sub-chamber 1912 increases and begins to resemble the teardrop shape. The screen material 1902 is positioned between the first sub-chamber 1910 and the second sub-chamber 1912. Collectively, the first sub-chamber 1910 and the second sub-chamber 1912 have a teardrop cross-section. As described above, the cross-sections of the first sub-chamber 1910 and the second sub-chamber 1912 transition to a circular cross-section at the first outlet 1710 and the second outlet 1712, respectively. A first diameter 2202 of the first outlet 1710 may be equal to a second diameter 2204 of the second outlet 1712 in some examples.

In this way, the third multiphase gas/bubble diverter 1702 may exploit passive capillary fluidic phenomena using wetting phenomena, geometry, and fluid properties to separate a two-phase flow by directing gaseous bubbles away from a screening element and passing liquid through the screening element. Dimensions of the first sub-chamber 1910, the second sub-chamber 1912, and the tapering teardrop geometry thereof are configurable based on an operational flow rate, thus enabling separation of liquid and gas flows from a multiphase flow across a range of flow rates. The tapering teardrop geometry includes the corner half-angle, the axial length, and the lateral distance between the first outlet and the second outlet, which may be configurable based on an operational flow rate, thus enabling separation of liquid and gas flows from a multiphase flow across a range of flow rates.

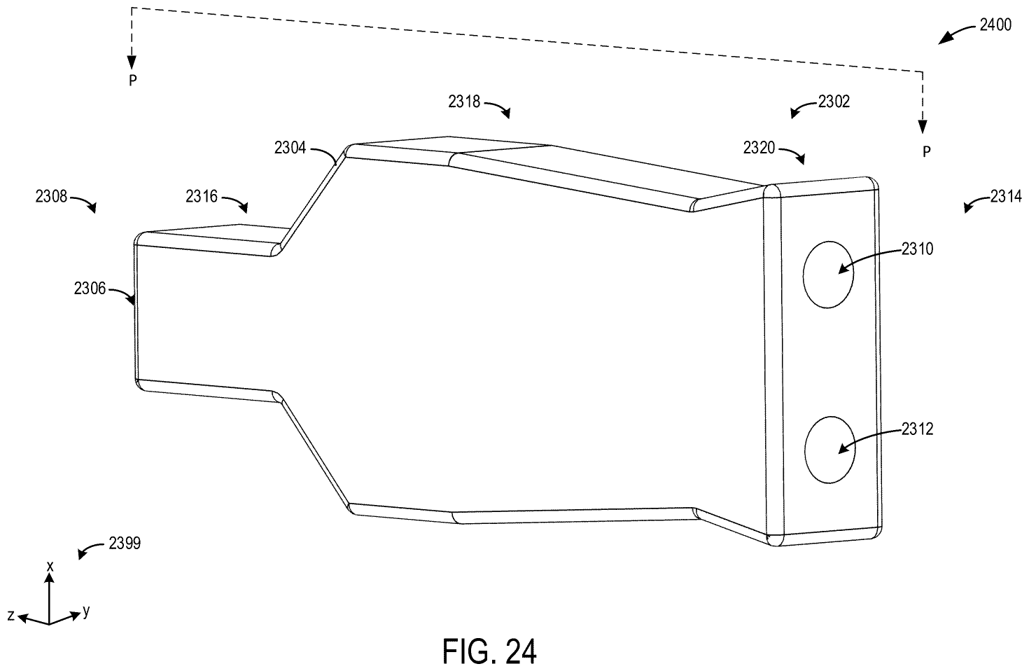

FIG. 23 shows a first perspective view 2300 of a fourth multiphase gas/bubble diverter 2302. FIG. 24 shows a second perspective view 2400 of the fourth multiphase gas/bubble diverter 2302. FIGS. 23 and 24 are described simultaneously herein. Reference axes 2399 are included in FIGS. 23-24 in order to compare the views and relative orientations described herein. Reference axes 2399 includes three axes, namely an x-axis, a y-axis, and a z-axis. A positive direction for each axis is indicated by an arrow and/or a filled in circle.

The fourth multiphase gas/bubble diverter 2302 comprises a body 2304 with an inlet 2306 at a first end 2308, and a first outlet 2310 and a second outlet 2312 at a second end 2314 opposite the first end 2308. The inlet 2306 may have a circular cross-section. The first outlet 2310 may have a circular cross-section. The second outlet 2312 may have a circular cross-section. A diameter of the inlet 2306 may be equal to a diameter of one or both of the first outlet 2310 and the second outlet 2312. The fourth multiphase gas/bubble diverter 2302 is formed of a single, monolithic body with chambers, sub-chambers, and a screening element for separating liquid and gas from a liquid-gas mixture into the sub-chambers. In this way, gas may be output via the first outlet 2310 and liquid may be output via the second outlet 2312.

The body 2304 may have an angular shape that increases and decreases in height along a length 2330 of the body 2304. An example shape of the body 2304 is described herein with respect to FIGS. 22 and 23, though the body 2304 may have other shapes without departing from the scope of the present disclosure. The body 2304 may be shaped to follow contours of internal chambers of the fourth multiphase gas/bubble diverter 2302, which may reduce an amount of material used, thus reducing a weight and a footprint of the fourth multiphase gas/bubble diverter 2302. The body 2304 comprises a first region 2316 with a rectangular cross-section. The first region 2316 has a first height 2322. The body 2304 further comprises a second region 2318 that is continuous with the first region 2316. A height of the second region 2318 (e.g., parallel to the z-axis) gradually increases from the first height 2322 to a second height 2326 along a first length 2332 of the second region 2318. The second region 2318 may have the second height 2326 for a second length 2334 of the second region 2318. The height of the second region 2318 gradually decreases from the second height 2326 to a third height 2336 at an interface between the second region 2318 and the third region 2320. A height of the third region 2320 gradually increases from the third height 2336 to a fourth height 2338 along a third length 2340 of the third region 2320.

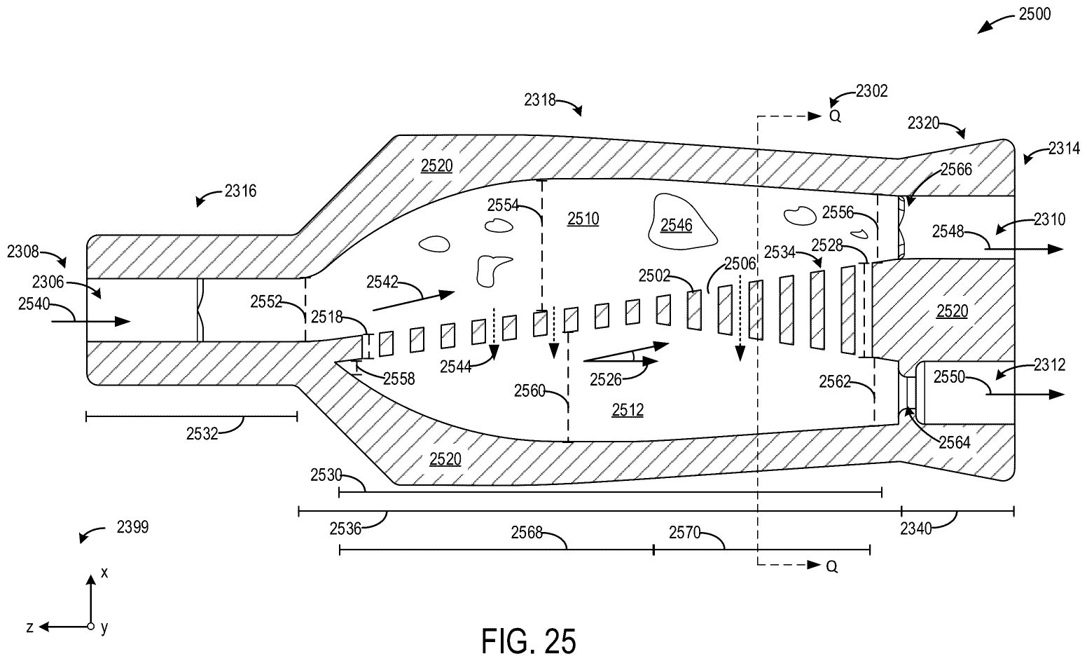

FIG. 25 shows a first cross-sectioned side view 2500 of the fourth multiphase gas/bubble diverter 2302. The fourth multiphase gas/bubble diverter 2302 is sectioned along a line P-P of FIGS. 23-24. A screening element 2534 is at least partially positioned in the second region 2318. The screening element 2534 is configured to selectively fluidly couple the inlet 2306 to the first outlet 2310 and the second outlet 2312. One or more of a first length 2532 of the first region 2316, a second length 2536 of the second region 2318, the third length 2340 of the third region 2320, and/or a screen length 2530 of the screening element 2534 may be varied at achieve liquid-gas separation at different flow rates. For example, for flow rates between >0 ml/s and 10 ml/s, the length 402 of the fourth multiphase gas/bubble diverter 2302 may be between 2 cm and 20 cm.

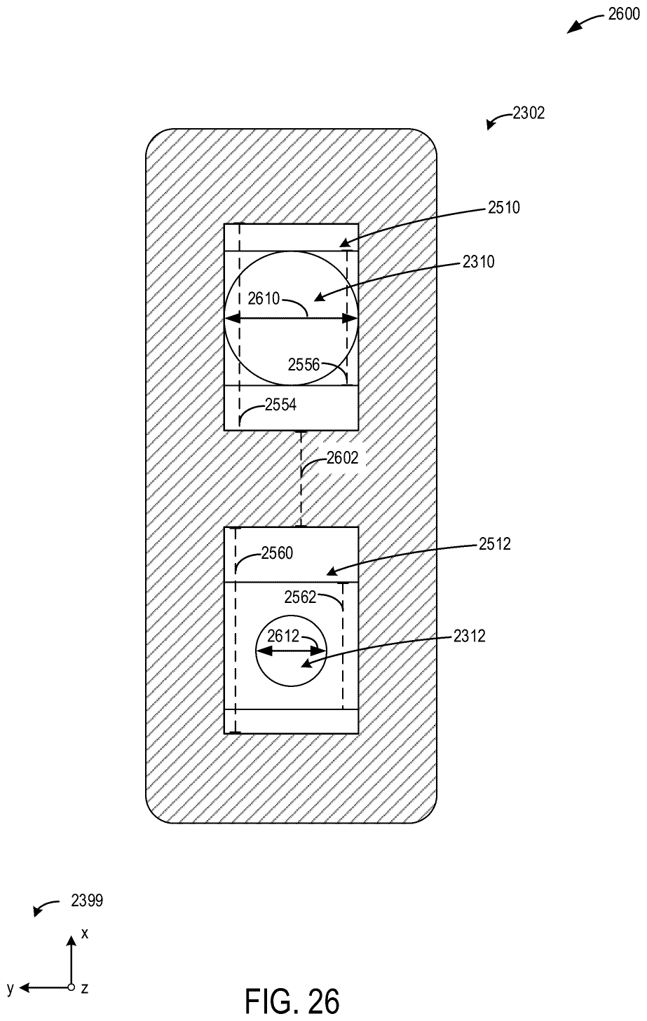

The fourth multiphase gas/bubble diverter 2302 is at least partially divided into two sub-chambers by the screening element 2534. A first sub-chamber 2510 extends between the inlet 2306 and the first outlet 2310. A second sub-chamber 2512 extends between the first end 2308 and the second outlet 2312. The second sub-chamber 2512 does not include the inlet 2306. One or more of the first sub-chamber 2510 and the second sub-chamber 2512 may have a circular and/or oval cross-section, as further described with respect to FIG. 26. The first sub-chamber 2510 and the second sub-chamber 2512 may have asymmetric geometries. A volume of the second sub-chamber 2512 may be greater than a volume of the first sub-chamber 2510. In other examples, the volumes of each of the first sub-chamber 2510 and the second sub-chamber 2512 may be approximately equal.

A height of each of the first sub-chamber 2510 and the second sub-chamber 2512 may gradually increase, then decreases from the first end 2308 to the second end 2314. For example, a first height 2552 of the first sub-chamber 2510 at the first end 2308 may be less than a second height 2554 at an approximate middle of the second length 2536 of the second region 2318. A third height 2556 of the first sub-chamber 2510 may be less than the second height 2326. The third height 2336 may be approximately equal to the first height 2552. A fourth height 2558 of the second sub-chamber 2512 at the first end 2308 may be less than a fifth height 2560 at the approximate middle of the second length 2536 of the second region 2318. A sixth height 2562 of the second sub-chamber 2512 at the second end 2314 may be less than the fifth height 2560. The sixth height 2562 may be greater than the fifth height 2560. In some examples, the third height 2336 and the sixth height 2562 may be approximately equal. A height of the second sub-chamber 2512 may further narrow at a second interface 2564 between the second sub-chamber 2512 and the second outlet 2312 to assist in directing liquid out of the second outlet 2312. A height of the first sub-chamber 2510 may be equal to the height of the first outlet 2310 (e.g., the diameter of the first outlet 2310) at a first interface 2566 between the first sub-chamber 2510 and the first outlet 2310.

The screening element 2534 is formed of an alternating series of screen material 2502 and gaps 2506 therebetween. The screening element 2534 is configured to wick liquid from the first sub-chamber 2510 to the second sub-chamber 2512 and block transmission of gas (e.g., gas bubbles) from the first sub-chamber 2510 to the second sub-chamber 2512. The screen material 2502 may be, for example, the same material which forms the internal walls 2520 of the fourth multiphase gas/bubble diverter 2302. In other examples, the screen material 2502 is formed of a different material than that forming the internal walls 2520. Gaps 2506 between the screen material 2502 may form bubble point flow channels.

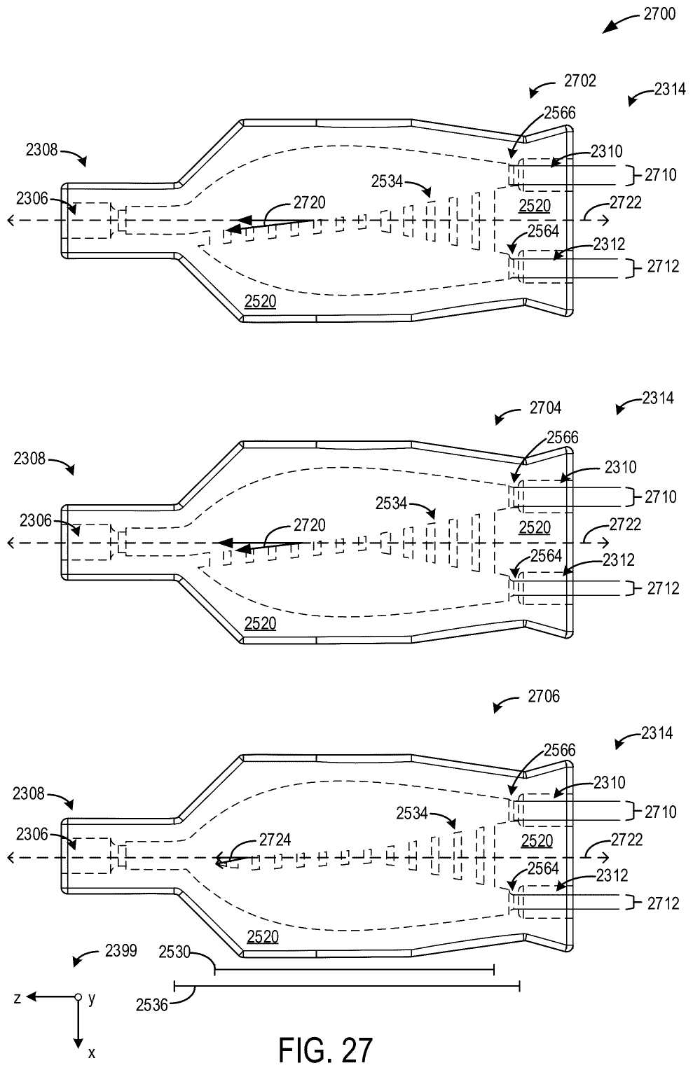

The screening element 2534 may extend from and/or be coupled to the internal wall 2520 of the fourth multiphase gas/bubble diverter 2302 at the second end 2314. The internal wall 2520 may extend between the first outlet 2310 and the second outlet 2312 in the third region 2320, such that there is no gap (e.g., air-filled space) between the first outlet 2310 and the second outlet 2312. The screening element 2534 may further be coupled to the internal wall 2520 of the fourth multiphase gas/bubble diverter 2302 at the first end 2308. The screening element 2534 may be positioned at a bias angle 2526 with respect to the z-axis of the reference axes 2399. The bias angle 2526 may be configured based on an operational flow rate of the fourth multiphase gas/bubble diverter 2302. For example, the screening element 2534 may be positioned at a larger bias angle 2526 in an embodiment of the fourth multiphase gas/bubble diverter 2302 configured to separate multiphase flows at higher flow rates, compared to an embodiment of the fourth multiphase gas/bubble diverter 2302 configured to separate multiphase flows at lower flow rates. For flow rates between >0 ml/s to 10 ml/s, the bias angle 2526 may be between 0 degrees and 45 degrees to enable liquid-gas separation. Additional example bias angles 2526 are described with respect to FIG. 27.

Screen material 2502 of the screening element 2534 may have a first height 2552 for a first portion 2568 of the screen length 2530. Along a second portion 2570 of the screen length 2530, a height of each piece of screen material 2502 may gradually increase from the first height 2518 to a second height 2528. A gap width (e.g., distance between pieces of screen material 2502) may be equal to a width of the screen material 2502, with respect to the z-axis, in some examples. In other examples, the gap width may be greater than or less than the width of the screen material width.

The screening element 2534 enables selective fluid communication between the first sub-chamber 2510 and the second sub-chamber 2512. Gaps 2506 between the screen material span an interface between the first sub-chamber 2510 and the second sub-chamber 2512. A liquid-gas mixture flows into the fourth multiphase gas/bubble diverter 2302 via the inlet 2306, as indicated by a first arrow 2540. The liquid-gas mixture flows into the first sub-chamber 2510, as illustrated by a second arrow 2542. The screening element 2534 wicks liquid through the gaps 2506 therebetween and into the second sub-chamber 2512, as illustrated by dashed arrows 2544. Gas bubbles 2546 are occluded from going through the screening element 2534. In this way, gas bubbles may remain in the first sub-chamber 2510 while liquid passes through the screening element 2534 into the second sub-chamber 2512. Gas may flow out of the first outlet 2310 as illustrated by a fourth arrow 2548. Liquid may flow out of the second outlet 2312 as illustrated by a fifth arrow 2550.

FIG. 26 shows a cross-sectioned end views 2600 of the fourth multiphase gas/bubble diverter 2302. The fourth multiphase gas/bubble diverter 2302 is sectioned along a line Q-Q of FIG. 25. The view 2600 of FIG. 26 looks from the first end 2308 towards the second end 2314. FIG. 26 shows a partial view of the first sub-chamber 2510 and the second sub-chamber 2512, and a view of the first outlet 2310 and the second outlet 2312. The fourth multiphase gas/bubble diverter 2302 may be symmetric with respect to the x-axis (e.g., the x-z plane). The fourth multiphase gas/bubble diverter 2302 has a rectangular cross section. A first diameter 2610 of the first outlet 2310 may be greater than a second diameter 2612 of the second outlet 2312 in some examples. The first outlet 2310 and the second outlet 2312 may be vertically separated (e.g., along the x-axis) by the internal wall 2520 having a wall height 2602. The distance between the first outlet 2310 and the second outlet 2312 (e.g., the wall height 2602) may be configured based on an operational flow rate of the fourth multiphase gas/bubble diverter 2302. For example, the wall height 2602 may be greater in an embodiment of the fourth multiphase gas/bubble diverter 2302 configured to separate multiphase flows at higher flow rates, compared to the wall height 2602 in an embodiment configured to separate multiphase flows at lower flow rates. For flow rates between >0 ml/s and 10 ml/s, the wall height 2602 may be between 0.5 cm and 5 cm.

FIG. 27 shows cross sections 2700 of three examples of the fourth multiphase gas/bubble diverter 2302 with varying outlet diameters and screening element bias angles. Diameters of the first outlet 2310 and the second outlet 2312 are configurable based on an operational flow rate, thus enabling separation of liquid and gas flows from a multiphase flow across a range of flow rates. For example, the second interface 2564 between the second sub-chamber 2512 and the second outlet 2312 may have a different diameter than the first interface 2566 between the first sub-chamber 2510 and the first outlet 2310. Diameters of the second interface 2564 and the first interface 2566 are illustrated by solid lines and labeled brackets. Additionally, the bias angle 2526 and the screen length of the screening element 2534 are configurable based on an operational flow rate, thus enabling separation of liquid and gas flows from a multiphase flow across a range of flow rates. A width of each of the first outlet 2310 and the second outlet 2312 are shown

A first example gas/bubble diverter 2702 shows the screening element 2534 positioned at a first bias angle 2720 with respect to a central axis 2722. The screening element 2534 extends from the internal wall 2520 at the second end 2314 to the internal wall 2520 at the first end 2308. A first diameter 2710 of the first interface 2566 is equal to a second diameter 2712 of the second interface 2564.

A second example gas/bubble diverter 2704 shows the screening element 2534 positioned at the first bias angle 2720 with respect to the central axis 2722. The screening element 2534 extends from the internal wall 2520 at the second end 2314 to the internal wall 2520 at the first end 2308. The first diameter 2710 of the first interface 2566 is greater than the second diameter 2712 of the second interface 2564.

A third example gas/bubble diverter 2706 shows the screening element 2534 positioned at a second bias angle 2724 with respect to the central axis 2722. The second bias angle 2724 may be less than the first bias angle 2720. The screening element 2534 extends from the internal wall 2520 at the second end 2314 along a portion of the second length 2536 of the second region 2318. The screen length 2530 is less than the second length 2536 of the second region 2318. The screening element 2534 may not be coupled to the internal wall 2520 at the first end 2308. The first diameter 2710 of the first interface 2566 is greater than the second diameter 2712 of the second interface 2564.

The bias angle 2526 may be configured based on an operational flow rate of the fourth multiphase gas/bubble diverter 2302. For example, the bias angle may be greater, as shown in the first example gas/bubble diverter 2702 and the second example gas/bubble diverter 2704, in a multiphase gas/bubble diverter configured to separate multiphase flows at higher flow rates, compared to the bias angle at which the screening element 2534 is positioned in a multiphase gas/bubble diverter configured to separate multiphase flows at lower flow rates, as shown in the third example gas/bubble diverter 2706. As described above, for flow rates between >0 ml/s to 10 ml/s, the bias angle 2526 may be between 0 degrees and 45 degrees to enable liquid-gas separation.

In this way, the fourth multiphase gas/bubble diverter 2302 may exploit passive capillary fluidic phenomena using wetting phenomena, geometry, and fluid properties to separate a two-phase flow by directing gaseous bubbles away from a screening element and passing liquid through the screening element. The bias angle of the screening element and the wall height between the first outlet and the second outlet, among other dimensions of the fourth multiphase gas/bubble diverter 2302 described herein, are configurable based on an operational flow rate, thus enabling separation of liquid and gas flows from a multiphase flow across a range of flow rates.

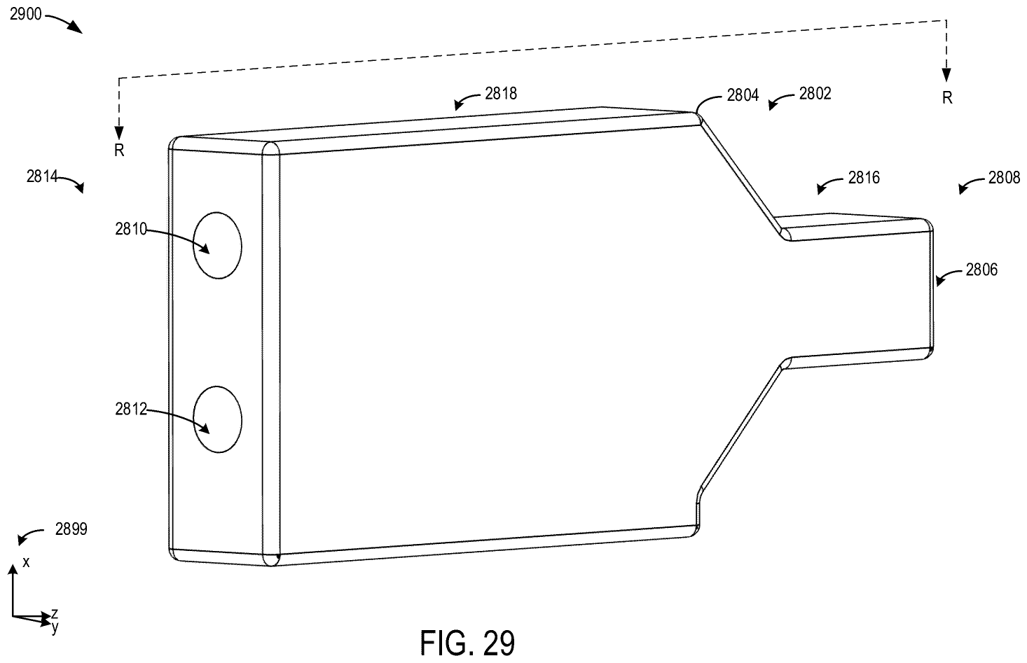

FIG. 28 shows a first perspective view 2800 of a fifth multiphase gas/bubble diverter 2802. FIG. 29 shows a second perspective view 2900 of the fifth multiphase gas/bubble diverter 2802. FIGS. 28-29 are described simultaneously herein. Reference axes 2899 are included in FIGS. 28-33 in order to compare the views and relative orientations described herein. Reference axes 2899 includes three axes, namely an x-axis, a y-axis, and a z-axis. A positive direction for each axis is indicated by an arrow and/or a filled in circle.

The fifth multiphase gas/bubble diverter 2802 comprises a body 2804 with an inlet 2806 at a first end 2808, and a first outlet 2810 and a second outlet 2812 at a second end 2814 opposite the first end 2808. The inlet 2806 may have a circular cross-section. The first outlet 2810 may have a circular cross-section. The second outlet 2812 may have a circular cross-section. A diameter of the inlet 2806 may be equal to a diameter of one or both of the first outlet 2810 and the second outlet 2812. The fifth multiphase gas/bubble diverter 2802 is formed of a single, monolithic body with chambers, sub-chambers, and a screening element for separating liquid and gas from a liquid-gas mixture into the sub-chambers. In this way, gas may be output via the first outlet 2810 and liquid may be output via the second outlet 2812.

The body 2804 may have a rectangular cross-section in the y-x plane. The body 2804 comprises a first region 2816 with a rectangular cross-section. The first region 2816 has a first height 2822. The body 2804 further comprises a second region 2818 that is continuous with the first region 2816. A height of the second region 2818 gradually increases from the first height 2822 to a second height 2826 along a first length 2832 of the second region 2818. The second height 2826 is greater than the first height 2822. The second region 2818 has the second height 2826 for a second length 2834 of the second region 2818.

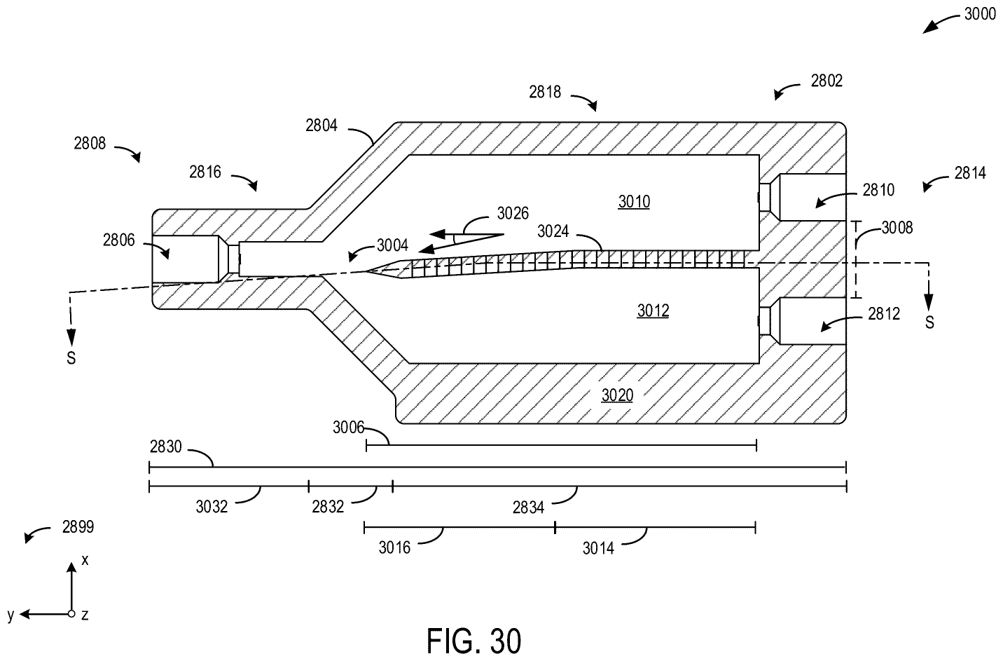

FIG. 30 shows a first cross-sectioned side view 3000 of the fifth multiphase gas/bubble diverter 2802. The fifth multiphase gas/bubble diverter 2802 is sectioned along a line R-R of FIGS. 28-29. A screening element 3024 is at least partially positioned in the second region 2818. The screening element 3024 is configured to selectively fluidly couple the inlet 2806 to the first outlet 2810 and the second outlet 2812. One or more of the first length 2832 of the second region 2818, the second length 2834 of the second region 2818, a length 3032 of the first region 2816, and/or a screen length 3006 of the screening element 3024 may be varied at achieve liquid-gas separation at different flow rates. For example, for flow rates between >0 ml/s and 10 ml/s, a length 2830 of the fifth multiphase gas/bubble diverter 2802 may be between 2 cm and 20 cm.

The fifth multiphase gas/bubble diverter 2802 is at least partially divided into two sub-chambers by the screening element 3024. A first sub-chamber 3010 extends between the inlet 2806 and the first outlet 2810. A second sub-chamber 3012 extends between the first end 2808 and the second outlet 2812. The second sub-chamber 3012 does not include the inlet 2806. One or more of the first sub-chamber 3010 and the second sub-chamber 3012 may have a rectangular cross-section. The first sub-chamber 3010 and the second sub-chamber 3012 may have asymmetric geometries. A volume of the first sub-chamber 3010 may be greater than a volume of the second sub-chamber 3012.

The screening element 3024 may extend from and/or be coupled to an internal wall 3020 of the fifth multiphase gas/bubble diverter 2802 at the second end 2814. There may be a gap 3004 between the screening element 3024 and the internal wall 3020 on the first end 2808 of the fifth multiphase gas/bubble diverter 2802. The screening element 3024 may extend a third portion (e.g., the screen length 3006) of the second region 2818. The screening element 3024 may be parallel to the y-axis for a first portion 3014 of the screening element 3024. The screening element 3024 is positioned at a bias angle 3026 with respect to the y-axis of the reference axes 2899 for a second portion 3016 of the screening element 3024. The bias angle 3026 may be configured based on an operational flow rate of the fifth multiphase gas/bubble diverter 2802. For example, the screening element 3024 may be positioned at a larger bias angle 3026 in an embodiment of the fifth multiphase gas/bubble diverter 2802 configured to separate multiphase flows at higher flow rates, compared to an embodiment of the fifth multiphase gas/bubble diverter 2802 configured to separate multiphase flows at lower flow rates. For flow rates between >0 ml/s to 10 ml/s, the bias angle 3026 may be between 0 degrees and 45 degrees to enable liquid-gas separation.

The internal wall 3020 may extend between the first outlet 2810 and the second outlet 2812, such that there is no gap (e.g., air-filled space) between the first outlet 2810 and the second outlet 2812. The first outlet 2810 and the second outlet 2812 may be vertically separated (e.g., along the x-axis) by the internal wall 3020 having a wall height 3008. The distance between the first outlet 2810 and the second outlet 2812 (e.g., the wall height 3008) may be configured based on an operational flow rate of the fifth multiphase gas/bubble diverter 2802. For example, the wall height 3008 may be greater in an embodiment of the fifth multiphase gas/bubble diverter 2802 configured to separate multiphase flows at higher flow rates, compared to the wall height 3008 in an embodiment configured to separate multiphase flows at lower flow rates. For flow rates between >0 ml/s and 10 ml/s, the wall height 3008 may be between 0.5 cm and 5 cm.

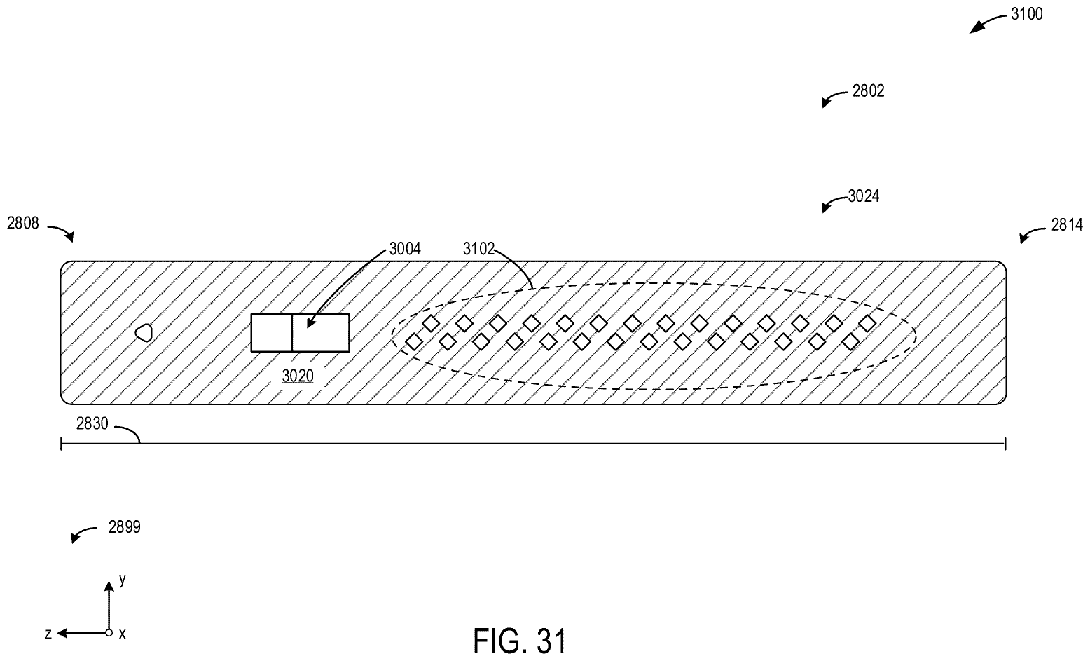

FIG. 31 shows a top-down cross-section view 3100 of the fifth multiphase gas/bubble diverter 2802. The fifth multiphase gas/bubble diverter 2802 is sectioned along a line S-S of FIG. 30. The view 3100 shows passages of the screening element 3024 that selectively fluidly couple the first sub-chamber 3010 and the second sub-chamber 3012 (not shown).

The screening element 3024 is formed as a porous splitter with a plurality of channels extending between the first sub-chamber 3010 and the second sub-chamber 3012. For example, the screening element 3024 may be configured as a porous mesh. In another example, the screening element 3024 may be configured as a planar sheet having through holes (e.g., the plurality of channels). The plurality of channels are shown in a dashed line circle 3102. The screening element 3024 is configured to wick liquid from the first sub-chamber 3010 to the second sub-chamber 3012 and block transmission of gas (e.g., gas bubbles) from the first sub-chamber 3010 to the second sub-chamber 3012. The screening element 3024 may be formed of a same material as that which forms the internal walls 3020 of the fifth multiphase gas/bubble diverter 2802. In other examples, the screening element 3024 is formed of a different material than that forming the internal walls 3020. The screening element 3024 may extend partially along the length 2830 of the fifth multiphase gas/bubble diverter 2802, and there exists the gap 3004 between the screening element 3024 and the internal wall 3020 on the first end 2808 of the fifth multiphase gas/bubble diverter 2802.

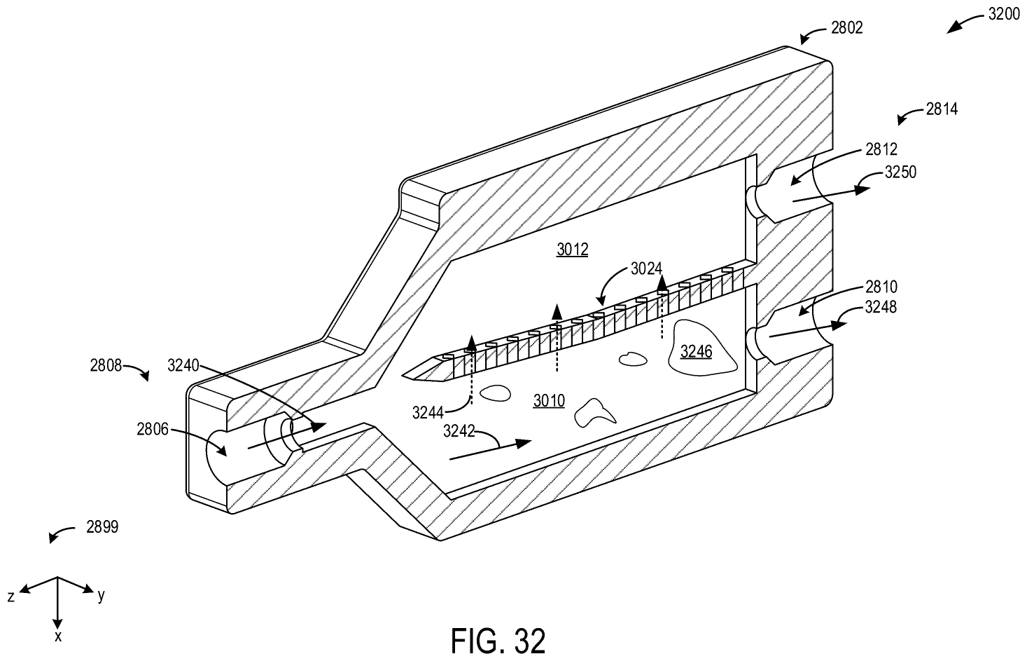

FIG. 32 shows a cross-sectioned perspective view 3200 of the fifth multiphase gas/bubble diverter 2802. The fifth multiphase gas/bubble diverter 2802 is sectioned across a line R-R of FIGS. 28-29. The screening element 3024 enables selective fluid communication between the first sub-chamber 3010 and the second sub-chamber 3012. Channels of the screening element 3024 span an interface between the first sub-chamber 3010 and the second sub-chamber 3012. A liquid-gas mixture flows into the fifth multiphase gas/bubble diverter 2802 via the inlet 2806, as indicated by a first arrow 3240. The liquid-gas mixture flows into the first sub-chamber 3010, as illustrated by a second arrow 3242. The screening element 3024 wicks liquid through the channels thereof and into the second sub-chamber 3012, as illustrated by dashed arrows 3244. Gas bubbles 3246 are occluded from going through the screening element 3024. In this way, gas bubbles may remain in the first sub-chamber 3010 while liquid passes through the screening element 3024 into the second sub-chamber 3012. Gas may flow out of the first outlet 2810 as illustrated by a fourth arrow 3248. Liquid may flow out of the second outlet 2812 as illustrated by a fifth arrow 3250.

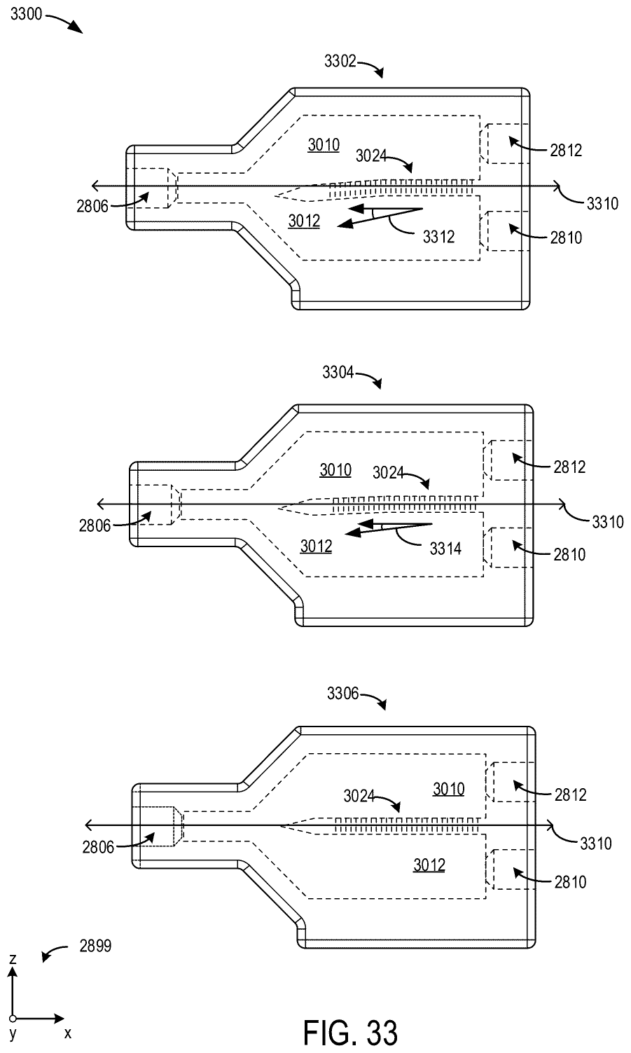

FIG. 33 shows example configurations 3300 of the fifth multiphase gas/bubble diverter 2802 where the screening element 3024 is positioned at different bias angles. A first example gas/bubble diverter 3302 shows the screening element 3024 positioned at a first bias angle 3312 with respect to a central axis 3310. A second example gas/bubble diverter 3304 shows the screening element 3024 positioned at a second bias angle 3314 with respect to the central axis 3310. The second bias angle 3314 is less than the first bias angle 3312. A third example gas/bubble diverter 3306 shows the screening element 3024 positioned parallel to the x-axis (e.g., the bias angle is equal to zero). The bias angle may be configured based on an operational flow rate of the fifth multiphase gas/bubble diverter 2802. For example, the bias angle may be greater, as shown in the first example gas/bubble diverter 3302, in a multiphase gas/bubble diverter configured to separate multiphase flows at higher flow rates, compared to the bias angle at which the screening element 3024 is positioned in a multiphase gas/bubble diverter configured to separate multiphase flows at lower flow rates, as shown in the second example gas/bubble diverter 3304 and the third example gas/bubble diverter 3306. As described above, for flow rates between >0 ml/s to 10 ml/s, the bias angle may be between 0 degrees and 45 degrees to enable liquid-gas separation.

Thus, the different bias angles of each embodiment differently splits the volumes of the first sub-chamber 3010 and the second sub-chamber 3012. For example, in the third example gas/bubble diverter 3306, the first sub-chamber 3010 and the second sub-chamber 3012 are substantially equal, and the bias angle is approximately zero degrees. In the second example gas/bubble diverter 3304, the bias angle is greater than the bias angle of the third example gas/bubble diverter 3306 and less than the bias angle of the first example gas/bubble diverter 3302. The first sub-chamber 3010 may have a greater volume than the second sub-chamber 3012. In the first example gas/bubble diverter 3302, the bias angle is greater than the bias angle of the third example gas/bubble diverter 3306 and the bias angle 3314 of the second example gas/bubble diverter 3304. The first sub-chamber 3010 may have a greater volume than the second sub-chamber 3012.

In this way, the fifth multiphase gas/bubble diverter 2802 may exploit passive capillary fluidic phenomena using wetting phenomena, geometry, and fluid properties to separate a two-phase flow by directing gaseous bubbles away from a screening element and passing liquid through the screening element. The bias angle of the perforated sheet and a number of gaps in the planar perforated sheet may be configurable based on an operational flow rate, thus enabling separation of liquid and gas flows from a multiphase flow across a range of flow rates.

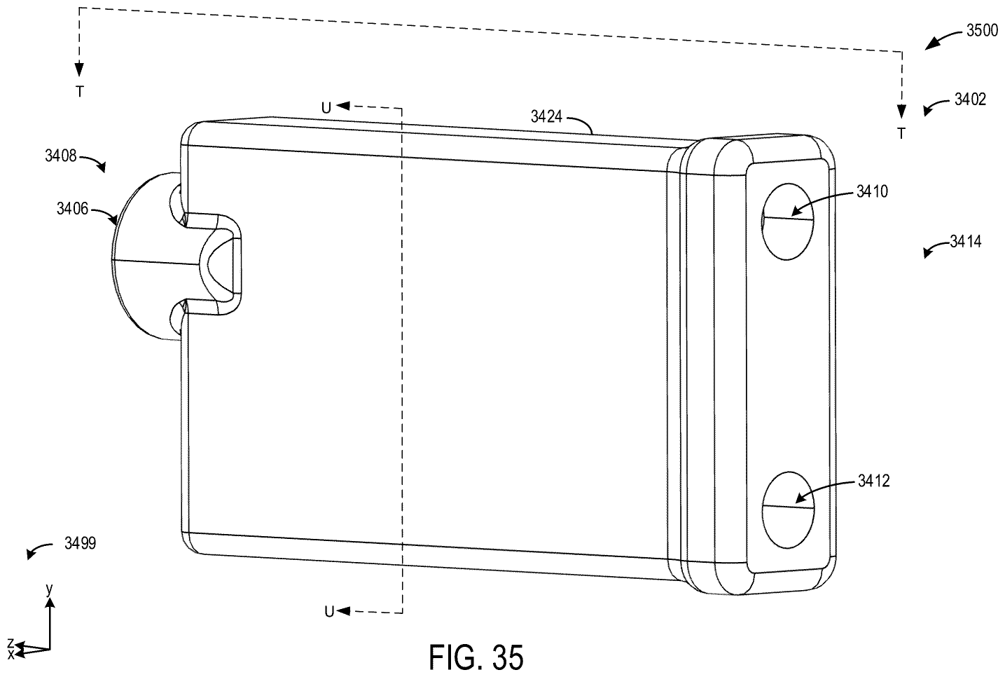

FIG. 34 shows a first perspective view 3400 of a sixth multiphase gas/bubble diverter 3402. FIG. 35 shows a second perspective view 3500 of the sixth multiphase gas/bubble diverter 3402. FIGS. 34-35 are described simultaneously herein. Reference axes 3499 are included in FIGS. 34-38 in order to compare the views and relative orientations described herein. Reference axes 3499 includes three axes, namely an x-axis, a y-axis, and a z-axis. A positive direction for each axis is indicated by an arrow and/or a filled in circle.

The sixth multiphase gas/bubble diverter 3402 comprises a body 3424 with an inlet 3406 at a first end 3408, and a first outlet 3410 and a second outlet 3412 at a second end 3414 that is opposite the first end 3408. The second end 3414 is opposite and distanced from the first end 3408 by a length 3420 of the body 3424. One or more of the inlet 3406, the first outlet 3410, and the second outlet 3412 may have a circular cross-section. The sixth multiphase gas/bubble diverter 3402 is formed of a single, monolithic body with chambers, sub-chambers, and a screening element for separating liquid and gas from a liquid-gas mixture into the sub-chambers. In this way, gas may be output via the first outlet 3410 and liquid may be output via the second outlet 3412.

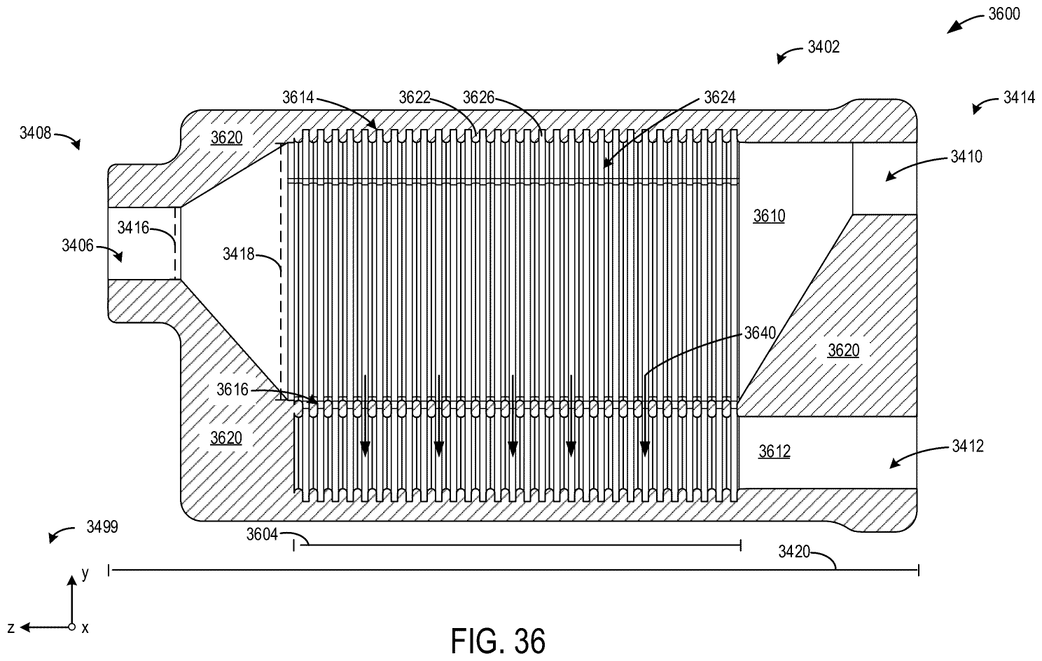

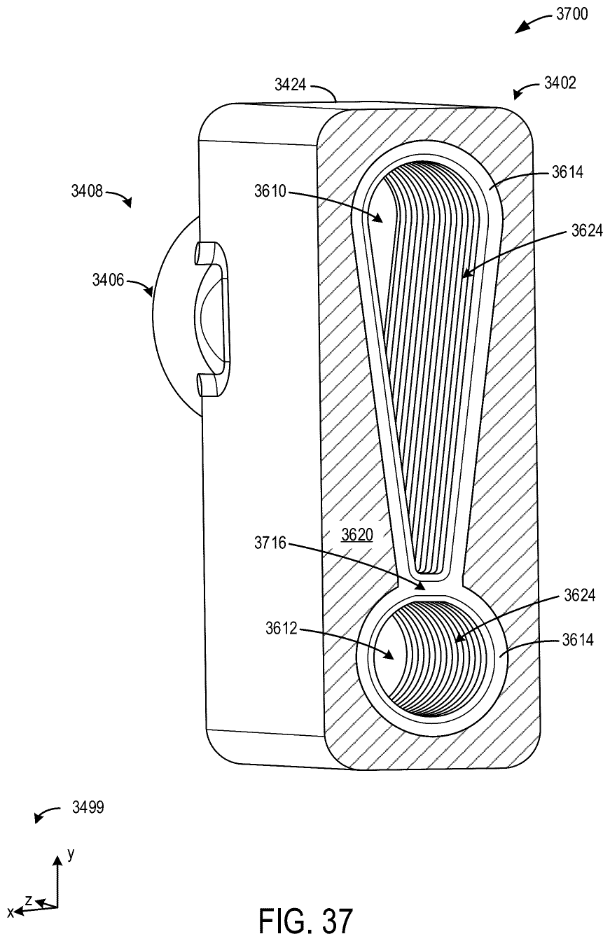

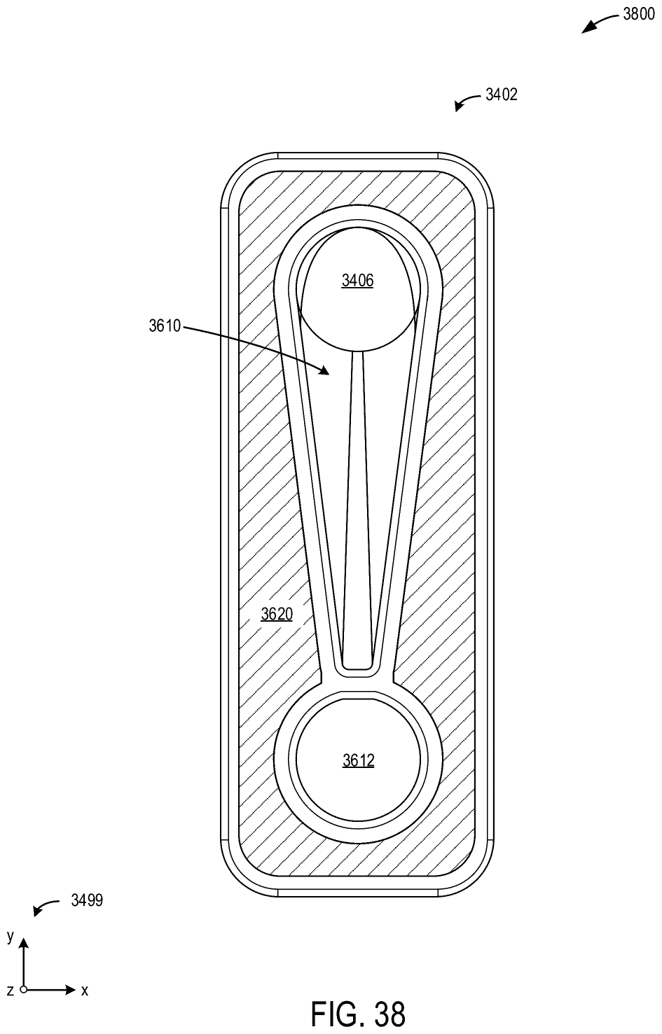

FIG. 36 shows a first cross-sectioned side view 3600 of the sixth multiphase gas/bubble diverter 3402. The sixth multiphase gas/bubble diverter 3402 is sectioned along a line T-T of FIGS. 34-35. The body 3424 may have a first height 3416 at the first end 3408. A height of the body 3424 gradually increases along the length 3420 of the body 3424 to a second height 3418, where the second height 3418 is greater than the first height 3416. As further described with respect to FIGS. 37-38, the body 3424 may have a rectangular cross-section. An interior of the body 3424 may have an exclamation point-shaped cross-section comprising a teardrop cross-section and a circular cross-section.

A screening element 3624 extends at least partially along the length 3420 of the body 3424. For example, the screening element 3624 may extend a first portion 3604 of the length 3420 of the chamber 304. The length 3420 of the body 3424 and/or the first portion 3604 of the length 3420 that the screening element 3624 extends along may be varied to achieve liquid-gas separation at different flow rates. For example, for flow rates between >0 ml/s and 35 ml/s, the length 3420 of the chamber 304 may be between 2 cm and 20 cm.

The sixth multiphase gas/bubble diverter 3402 is at least partially divided into two sub-chambers by the screening element 3624. A first sub-chamber 3610 extends between the inlet 3406 and the first outlet 3410. A second sub-chamber 3612 extends between internal walls 3620 of the sixth multiphase gas/bubble diverter 3402 at the first end 3408, and the second outlet 3412. The second sub-chamber 3612 does not include the inlet 3406. The screening element 3624 may be coupled to an internal wall 3620 at the second end 3414 of the sixth multiphase gas/bubble diverter 3402 between the first outlet 3410 and the second outlet 3412. The screening element 3624 may further be coupled to the internal wall 3620 of the sixth multiphase gas/bubble diverter 3402 at the first end 3408. The screening element 3624 comprises an alternating series of screen material and gaps therebetween. The screen material may be, for example, the same material which forms the internal walls 3620 of the sixth multiphase gas/bubble diverter 3402. In other examples, the screen material is formed of a different material than that forming the internal walls 3620.

The screening element 3024 is configured to wick liquid from the first sub-chamber 3610 to the second sub-chamber 3612 and block transmission of gas (e.g., gas bubbles) from the first sub-chamber 3610 to the second sub-chamber 3612. Gaps between the screen material form bubble point flow channels 3616 and cusp channels 3614. The bubble point flow channels 3616 span between the first sub-chamber 3610 and the second sub-chamber 3612. The cusp channels 3614 may extend into internal walls 3620 of the sixth multiphase gas/bubble diverter 3402. The cusp channels 3614 have villi-like structures which extend along internal walls 3620 of the sixth multiphase gas/bubble diverter 3402. For example, the cusp channels 3614 may extend along the first sub-chamber 3610 and the second sub-chamber 3612. Described another way, the cusp channels 3614 are formed of a series of projections 3622 from the internal walls 3620 of the first sub-chamber 3610 and the second sub-chamber 3612 towards a center of the sixth multiphase gas/bubble diverter 3402. Cavities 3626 are formed between each of the series of projections 3622. The cusp channels 3614 thus increase a surface area of the first sub-chamber 3610 and the second sub-chamber 3612. This may increase a wetting ability of the sixth multiphase gas/bubble diverter 3402, compared to wetting abilities of multiphase gas/bubble diverters without cusp channels, e.g., where walls of sub-chambers are continuous without projections and/or cavities that increase wall surface area. For example, the cusp channels 3614 may make first sub-chamber 3610 and/or the second sub-chamber 3612 perfectly wetting. The projections 3622 may be equally sized and spaced. The cavities 3626 may have the same depth that extends into the internal walls 3620. Cusp channels 3614 may be included on all internal walls 3620 of the sixth multiphase gas/bubble diverter 3402 in the first sub-chamber 3610 and the second sub-chamber 3612, as further shown in FIG. 37.

The screening element 3624 enables selective fluid communication between the first sub-chamber 3610 and the second sub-chamber 3612. Gaps between the screen material span an interface between the first sub-chamber 3610 and the second sub-chamber 3612. A multiphase fluid comprising liquid and gas enters the sixth multiphase gas/bubble diverter 3402 via the inlet 3406. Liquid is drawn through the screening element 3624 from the first sub-chamber 3610 to the second sub-chamber 3612, as illustrated by arrows 3640. Gaseous bubbles are retained in the first sub-chamber 3610. Gas exits the sixth multiphase gas/bubble diverter 3402 via the first outlet 3410. Liquid exits the sixth multiphase gas/bubble diverter 3402 via the second outlet 3412.

Turning to FIG. 37, a first cross-sectioned end view 3700 of the sixth multiphase gas/bubble diverter 3402 is shown. The sixth multiphase gas/bubble diverter 3402 is sectioned along a line U-U of FIG. 35. The body of the sixth multiphase gas/bubble diverter 3402 may have a rectangular cross-section. The first sub-chamber 3610 and the second sub-chamber 3612 collectively have an exclamation point-shaped cross-section. For example, the first sub-chamber 3610 has a teardrop cross-section and the second sub-chamber 3612 has a circular cross-section. The screening element 3624 extends across an intersection 3716 (e.g., between the first sub-chamber 3610 and the second sub-chamber 3612. The bubble point flow channels extend through the intersection 3716 between the first sub-chamber 3610 and the second sub-chamber 3612 and thus provide a pathway through which liquid may flow from the first sub-chamber 3610 to the second sub-chamber 3612. The bubble point flow channels may not be shown in the first cross-section view 3700 of FIG. 37, as the sixth multiphase gas/bubble diverter 3402 is sectioned at a portion of screening material of the screening element 3624, and not at a gap therebetween.

FIG. 38 shows a second cross-sectioned end view 3800 of the sixth multiphase gas/bubble diverter 3402 is shown. The sixth multiphase gas/bubble diverter 3402 is sectioned along a line U-U of FIG. 35. The view 3800 looks from the second end 3414 to the first end 3408, and includes visualization of the inlet 3406, the first sub-chamber 3610, and the second sub-chamber 3612.

In this way, the sixth multiphase gas/bubble diverter 3402 of FIGS. 34-38 may exploit passive capillary fluidic phenomena using wetting phenomena, geometry, and fluid properties to separate a two-phase flow by directing gaseous bubbles away from a screening element and passing liquid through the screening element. The exclamation point-shaped cross-section of the first sub-chamber and the second sub-chamber, including tapering teardrop geometry and the circular cross-section, may be configurable based on an operational flow rate, thus enabling separation of liquid and gas flows from a multiphase flow across a range of flow rates.

The examples of the multiphase gas/bubble diverter shown in FIGS. 1-38 may be incorporated in a multiphase system and used to separate a two-phase flow of liquid and gas into single phase streams. FIG. 39 shows an example multiphase separating system 3900 with an example of the second multiphase gas/bubble diverter 902 of FIGS. 9-16 incorporated therein. A multiphase flow, such as a two-phase bubbly flow including liquid and gaseous bubbles is directed into the second multiphase gas/bubble diverter 902 via the inlet 906. As described herein, characteristics of the multiphase gas/bubble diverter such as the screening element, the bias angle, the corner half-angle, the axial length, the cross-sectional shape of the first sub-chamber and the second sub-chamber, and the distance between the first outlet and the second outlet may be configured to exploit passive capillary fluidic phenomena using wetting phenomena, geometry, and fluid properties to separate a two-phase flow by directing gaseous bubbles away from the screening element 1224 and passing liquid through the screening element 1224. Liquid is diverted from the first sub-chamber 1210 to the second sub-chamber 1212 via the screening element 1224. Gas bubbles are retained in the first sub-chamber 1210. Gas bubbles are directed out of the first sub-chamber 1210 into a wedge channel 1102 via the first outlet 910. Liquid is directed out of the second sub-chamber 1212 into the wedge channel 1102 via the second outlet 912. Bubbles entering the wedge channel 1102 are readily separated by capillary flows in the wedge channel 1102.

Examples of the multiphase gas/bubble diverter described with respect to FIGS. 1-38 may be operated to separate liquid and gas of a liquid-gas mixture into single streams of liquid and gas (e.g., a liquid stream and a gas stream) according to a method described with respect to FIG. 40. FIG. 40 illustrates an example method 4000 for operating the multiphase gas/bubble diverter. The method 4000 may be used to operate any multiphase gas/bubble diverter described herein which is coupled to a liquid-gas mixture source at the inlet and having a backpressure source upstream of the multiphase gas/bubble diverter.

At 4002, the method 4000 includes directing a liquid-gas mixture from a liquid-gas source into an inlet of a multiphase gas/bubble diverter. As described herein, the multiphase gas/bubble diverter comprises a chamber with a screening element extending at least partially along a length of the chamber and dividing the chamber into a first sub-chamber extending between an inlet and a first outlet of the chamber and a second sub-chamber extending between a first end, not including the inlet, and a second outlet of the chamber. For example, the liquid-gas source may be a gas source and a liquid source which are both connected to the multiphase gas/bubble diverter at the inlet. In another example, the liquid-gas source may be a single source containing the liquid-gas mixture, coupled to the inlet.

At 4004, the method 4000 includes directing the liquid-gas mixture through the screening element. Due to the configuration of the multiphase gas/bubble diverter, including a height and/or a bias angle of the screening element, directing the liquid-gas mixture through the screening element includes directing liquid through the screening element from the first sub-chamber into the second sub-chamber while retaining bubbles of the multiphase flow in the first sub-chamber.

At 4006, the method 4000 includes directing gas bubbles out of the first sub-chamber of the multiphase gas/bubble diverter via the first outlet. Additionally, at 4008, the method 4000 includes directing liquid out of the second sub-chamber of the multiphase gas/bubble diverter via the second outlet.

In this way, a multiphase gas/bubble diverter including a chamber separated into two sub-chambers by a screening element which enables fluidic communication therebetween may perform liquid-gas phase separations for a multiphase flow of a wide range of flow rates. Furthermore, the multiphase gas/bubble diverter advantageously has no moving parts, low pressure losses, constant pressure drop, and no additional power consumption due to its passive separation method utilizing motive fluid streams, geometric flow components, and capillary (wicking) forces.

The disclosure also provides support for a bubble diverter, comprising an inlet at a first end of a body, a first outlet and a second outlet at a second end of the body, opposite the first end, a channel extending from the inlet to the first outlet and the second outlet along a length and width of the body, and a screening element extending linearly along the length of the body and dividing the channel into a first region extending from the inlet to the first outlet, and a second region extending from, and not including, the inlet to the second outlet, wherein the screening element is configured to divert liquid entering the bubble diverter via the inlet to the second region and out of the bubble diverter via the second outlet, and further divert gas entering the bubble diverter via the inlet into the first region and out of the bubble diverter via the first outlet. In a first example of the system, a first diameter of the channel at the first end is less than a second diameter of the channel at the second end. In a second example of the system, optionally including the first example, the bubble diverter has a teardrop cross-section comprising a first wall of the body which extends linearly from the first end to the second end, a second wall of the body, opposite the first wall, which extends linearly from the first end to the second end at an acute angle relative to the first wall, and a third wall and a fourth wall curvedly and seamlessly coupling the first wall and the second wall. In a third example of the system, optionally including one or both of the first and second examples, the screening element extends along the length of the body at an angle parallel to the acute angle of the second wall. In a fourth example of the system, optionally including one or more of each of the first through third examples, a width of the screening element increases from the first end to the second end, extending equally into both of the first region and the second region. In a fifth example of the system, optionally including one or more of each of the first through fourth examples, the bubble diverter has a rectangular cross-section comprising a pair of symmetrical walls extending from the first end to the second end, each wall of the pair of symmetrical walls extending linearly from the inlet at a first acute angle relative to a centerline for a first length, extending linearly for a second length parallel to the centerline, extending towards the centerline for a third length, and extending from the centerline at a second acute angle for a fourth length, and a planar third wall and a planar fourth wall seamlessly coupling the pair of symmetrical walls. In a sixth example of the system, optionally including one or more of each of the first through fifth examples, the screening element comprises a first width for the first length, the second length, and approximately a first half of the third length, and a second width at the second end, a width of the screening element linearly increasing from the first width to the second width from a second half of the third length and the fourth length and extending equally into the first region and the second region. In a seventh example of the system, optionally including one or more of each of the first through sixth examples, the screening element extends along the length of the body at acute angle with respect to the centerline. In an eighth example of the system, optionally including one or more of each of the first through seventh examples, a first outlet diameter of the first outlet is greater than a second outlet diameter of the second outlet. In a ninth example of the system, optionally including one or more of each of the first through eighth examples, a width of a screen segment is equal to a width of a gap on either side adjacent to the screen segment. In a tenth example of the system, optionally including one or more of each of the first through ninth examples, a width of a screen segment is less than a width of a gap on either side adjacent to the screen segment.

In another representation, a multiphase device comprises a chamber with an inlet and an outlet, wherein walls of the chamber have cusp channels along an interior of the chamber, the cusp channels comprised of a series of projections from the walls of the chamber channel towards the interior of the chamber, with a cavity formed between each of the series of projections. In a first example, the multiphase device is one of a heat exchanger, a terrestrial heat pipe, a space heat pipe, and a multiphase gas/bubble diverter with a screening element.

The disclosure also provides support for a multiphase gas/bubble diverter, comprising: a chamber having an inlet at a first end, and a first outlet and a second outlet at a second end opposite the first end, and a screening element extending at least partially from the second end to the first end along a length of the chamber, the screening element at least partially dividing the chamber into a first sub-chamber extending between the inlet and the first outlet and a second sub-chamber extending between the first end, not including the inlet, and the second outlet. In a first example of the system, the second end is opposite and distanced from the first end by the length of the chamber. In a second example of the system, optionally including the first example, the screening element is coupled to an internal end wall at the second end of the multiphase gas/bubble diverter between the first outlet and the second outlet. In a third example of the system, optionally including one or both of the first and second examples, the screening element is further coupled to an internal bottom wall of the multiphase gas/bubble diverter at the first end, the internal bottom wall extending between the second outlet and the inlet. In a fourth example of the system, optionally including one or more or each of the first through third examples, the screening element is a planar mesh with a plurality of holes extending between and fluidly coupling the first sub-chamber and the second sub-chamber. In a fifth example of the system, optionally including one or more or each of the first through fourth examples, the screening element is formed of an alternating series of screen material and gaps therebetween, where a screen material is coupled to a first internal side wall and a second internal side wall of the multiphase gas/bubble diverter, the second internal side wall opposite and distanced from the first internal side wall by a width of the chamber. In a sixth example of the system, optionally including one or more or each of the first through fifth examples, a height of the screening element increases from the first end to the second end. In a seventh example of the system, optionally including one or more or each of the first through sixth examples, the screening element has a first height at a first end of the screening element and a second height at a second end of the screening element, the second end opposite and distanced from the first end by a length of the screening element, and the second height equal to the first height. In an eighth example of the system, optionally including one or more or each of the first through seventh examples, the chamber is symmetric across a vertical plane which divides the multiphase gas/bubble diverter along a diameter of each of the first outlet, the second outlet, and the inlet, and the screening element divides the chamber such that the first sub-chamber and the second sub-chamber are asymmetric. In a ninth example of the system, optionally including one or more or each of the first through eighth examples, the screening element is positioned at a bias angle in a horizontal plane, with respect to the vertical plane, such that a cross-section of the first sub-chamber taken along the vertical plane has a different geometry compared to a cross-section of the second sub-chamber taken along the vertical plane.

The disclosure also provides support for a method for multiphase separation of a multiphase flow, comprising, directing the multiphase flow into a multiphase gas/bubble diverter comprising a chamber with a screening element extending at least partially along a length of the chamber and dividing the chamber into a first sub-chamber extending between an inlet and a first outlet of the chamber and a second sub-chamber extending between a first end, not including the inlet, and a second outlet of the chamber, directing liquid of the multiphase flow through the screening element from the first sub-chamber into the second sub-chamber while retaining bubbles of the multiphase flow in the first sub-chamber, directing bubbles out of the first sub-chamber via the first outlet, and directing liquid out of the second sub-chamber via the second outlet. In a first example of the method, directing the multiphase flow into the multiphase gas/bubble diverter comprises directing the multiphase flow in a first axial direction from the inlet towards the first outlet and the second outlet. In a second example of the method, optionally including the first example, directing liquid of the multiphase flow through the screening element comprises pulling liquid through gaps of the screening element via capillary flow. In a third example of the method, optionally including one or both of the first and second examples, the multiphase flow having a first flow rate is directed into the multiphase gas/bubble diverter with the screening element positioned at a first bias angle between 0 degrees and 45 degrees, where the first flow rate is between 0 milliliters per second (ml/s) to 10 ml/s. In a fourth example of the method, optionally including one or more or each of the first through third examples, the multiphase flow having a first flow rate is directed into the multiphase gas/bubble diverter having a first axial length of the chamber, the first axial length between 2 centimeters (cm) and 20 cm, where the first flow rate is between >0 ml/s and 10 ml/s. In a fifth example of the method, optionally including one or more or each of the first through fourth examples, the multiphase flow having a first flow rate is directed into the multiphase gas/bubble diverter having a first lateral distance between the first outlet and the second outlet, the first lateral distance between 0.5 cm and 5 cm, where the first flow rate is between >0 ml/s and 10 ml/s.

The disclosure also provides support for a bubble diverter which exploits passive capillary fluidic phenomena using wetting phenomena, geometry, and fluid properties to separate a two-phase flow by directing gaseous bubbles away from a screening element and passing liquid through the screening element. In a first example of the system, the screening element separates the bubble diverter into a first sub-chamber and a second sub-chamber having a different geometry from the first sub-chamber. In a second example of the system, optionally including the first example, the bubble diverter comprises a tapering teardrop geometry with a corner half-angle, an axial length, and a lateral distance between a first outlet and a second outlet. In a third example of the system, optionally including one or both of the first and second examples, the screening element is positioned at a bias angle, the bias angle enabling two-phase flow separation at a flow rate.

FIGS. 1-39 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A multiphase gas/bubble diverter, comprising:
a body;
an inlet at a first end of the body;
a first outlet and a second outlet at a second end of the body, opposite the first end; and
a screening element that divides an internal cavity of the body into a first sub-chamber that fluidly couples the inlet to the first outlet, and a second sub-chamber that is fluidly coupled to the second outlet.

2. The multiphase gas/bubble diverter of claim 1, wherein the second sub-chamber is selectively fluidly coupled to the inlet via the screening element.

3. The multiphase gas/bubble diverter of claim 1, wherein the body has a rectangular cross-section.

4. The multiphase gas/bubble diverter of claim 1, wherein the body has a teardrop cross-section.

5. The multiphase gas/bubble diverter of claim 1, wherein the screening element extends at least partially along a length of the multiphase gas/bubble diverter.

6. The multiphase gas/bubble diverter of claim 1, wherein the first sub-chamber and the second sub-chamber have asymmetric geometries.

7. The multiphase gas/bubble diverter of claim 1, wherein the screening element is positioned at a bias angle with respect to a central axis of the multiphase gas/bubble diverter.

8. The multiphase gas/bubble diverter of claim 1, wherein the screening element is formed of an alternating series of screen material and gaps therebetween, where the gaps extend between and selectively fluidly couple the first sub-chamber and the second sub-chamber.

9. The multiphase gas/bubble diverter of claim 1, wherein the screening element is formed of a porous mesh with a plurality of holes extending between and fluidly coupling the first sub-chamber and the second sub-chamber.

10. The multiphase gas/bubble diverter of claim 1, wherein the screening element further comprises cusp channels that extend radially into internal walls of the first sub-chamber and the second sub-chamber.

11. The multiphase gas/bubble diverter of claim 1, wherein the screening element is configured to wick liquid from the first sub-chamber to the second sub-chamber and to block transmission of gas from the first sub-chamber to the second sub-chamber.

12. The multiphase gas/bubble diverter of claim 1, wherein a height of the screening element gradually increases from the first end to the second end.

13. A method for multiphase separation of a multiphase flow, comprising;
directing the multiphase flow into a first sub-chamber of a multiphase gas/bubble diverter via an inlet;
directing liquid of the multiphase flow through a screening element from the first sub-chamber into a second sub-chamber while retaining bubbles of the multiphase flow in the first sub-chamber;
directing bubbles out of the first sub-chamber via a first outlet; and
directing liquid out of the second sub-chamber via a second outlet.

14. The method of claim 13, wherein the multiphase flow having a first flow rate is directed into the multiphase gas/bubble diverter with the screening element positioned at a first bias angle between 0 degrees and 45 degrees, where the first flow rate is between 0 milliliters per second (ml/s) to 10 ml/s.

15. The method of claim 13, wherein the multiphase flow having a first flow rate is directed into the multiphase gas/bubble diverter having a first length between 2 centimeters (cm) and 20 cm, where the first flow rate is between >0 ml/s and 10 ml/s.

16. The method of claim 13, wherein the multiphase flow having a first flow rate is directed into the multiphase gas/bubble diverter having a first lateral distance between the first outlet and the second outlet, the first lateral distance between 0.5 cm and 5 cm, where the first flow rate is between >0 ml/s and 10 ml/s.

17. A multiphase gas/bubble diverter, comprising:
wetting phenomena, geometry, and fluid properties which exploit passive capillary fluidic phenomena to separate a two-phase flow by directing gaseous bubbles away from a screening element and passing liquid through the screening element.

18. The multiphase gas/bubble diverter of claim 17, wherein the screening element separates the multiphase gas/bubble diverter into a first sub-chamber and a second sub-chamber having a different geometry from the first sub-chamber.

19. The multiphase gas/bubble diverter of claim 18, wherein the screening element selectively fluidly couples the first sub-chamber to the second sub-chamber.

20. The multiphase gas/bubble diverter of claim 17, wherein the multiphase gas/bubble diverter comprises a tapering teardrop geometry with a corner half-angle, an axial length, and a lateral distance between a first outlet and a second outlet.
